(19) United States
(12) Patent Application Publication
(10) Pub. No.: US 2026/0023967 A1
(43) Pub. Date: Jan. 22, 2026

(54) LOOP TRANSFORMATION IN TENSOR COMPILERS OF DEEP NEURAL NETWORKS (DNNS)

(71) Applicant: Intel Corporation, Santa Clara, CA (US)

(72) Inventors: Hongbo Rong, San Jose, CA (US); Sasikanth Avancha, Karnataka (IN); Alexander Heinecke, San Jose, CA (US); Evangelos Georganas, San Jose, CA (US); Xin Chen, Los Altos, CA (US); Kavitha Madhu, Bangalore (IN); Mingzhe Zhang, Beijing (CN)

(21) Appl. No.: 19/099,182

(22) PCT Filed: Sep. 2, 2022
(86) PCT No.: PCT/CN2022/116853

§ 371 Date: Jan. 28, 2025

(51) Int. Cl. G06N 3/08

(52) U.S. Cl. CPC G06N 3/08

(57) ABSTRACT

A tensor compiler for DNNs can use trained models for optimizing loop nests in IRs. A loop nest may include loops. A loop may be nested within another loop. A loop specifies a tensor operation to be repeatedly executed by a processor. The tensor compiler generates a schedule tree for an IR. The schedule tree includes schedules arranged based on hierarchies. The tensor compiler may select a schedule from the schedule tree by using a trained model that can predict performances of the processor executing the tensor operation in accordance with the IR transformed using the schedules. The tensor compiler then transforms the loop nest with the selected schedule and generates an implementation to be run by the processor. The tensor compiler may instrument the implementation for facilitating receipt of runtime performance information of the processor. The tensor compiler may use the runtime performance information to further train the model.

### TECHNICAL FIELD

This disclosure relates generally to neural networks, and more specifically, to loop transformation in tensor compilers of DNNs.

### BACKGROUND

DNNs are used extensively for a variety of artificial intelligence applications ranging from computer vision to speech recognition and natural language processing due to their ability to achieve high accuracy. However, the high accuracy comes at the expense of significant energy cost. DNNs have extremely high computing demands as each inference can require hundreds of millions of tensor operations, such as convolution, pooling operation, elementwise operations, and other types of tensor operations. Therefore, techniques to improve energy efficiency of DNNs are needed.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates an example DNN, in accordance with various embodiments.

FIG. 2 illustrates a tensor computation environment, in accordance with various embodiments.

FIG. 3 is a block diagram of tensor compiler, in accordance with various embodiments.

FIG. 4 is a block diagram of a schedule engine, in accordance with various embodiments.

FIG. 5 is a block diagram of a schedule generator, in accordance with various embodiments.

FIG. 6 illustrates a schedule tree of an intermediate representation (IR), in accordance with various embodiments.

FIG. 7 is a flowchart showing a method of loop transformation for deep learning, in accordance with various embodiments.

FIG. 8 is a flowchart showing a method of generating a schedule tree for an IR, in accordance with various embodiments.

FIG. 9 is a flowchart showing another method of generating a schedule tree for an IR, in accordance with various embodiments.

FIG. 10 illustrates a deep learning environment, in accordance with various embodiments.

FIG. 11 is a block diagram of an example DNN system, in accordance with various embodiments.

FIG. 12 is a block diagram of an example computing device, in accordance with various embodiments.

### DETAILED DESCRIPTION

### Overview

DNNs are widely used in the domains of computer vision, speech recognition, image, and video processing mainly due to their ability to achieve beyond human-level accuracy. Tensor computation is a key of deep learning. Tensor computation is often accelerated by vendor-specific expert-written libraries (e.g., OneDNN and CuDNN), of monolithic kernels. Another method to accelerate tensor computation is to use libraries of microkernels. Compared with monolithic kernels, microkernels can be more primitive in functionality and are meant to be composed together into bigger kernels. Just-In-Time (JIT) compilers have been introduced to optimize DNNs built around microkernels. For example, PlaidML JIT compiler optimizes DNNs and generates calls to a library of microkernels, namely TPP (Tensor Processing Primitives).

A problem faces microkernel-based JIT tensor compilers is how to identify an efficient sequence of loop transformations that can minimize data movement across a memory hierarchy and maximizes parallelism within limited compile time budget. A microkernel focuses on optimizing the usage of registers, and leaves caches to be taken care of by the JIT compiler. The compiler often needs to tile a given loop nest for each of the memories (e.g., registers, L1 cache, L2 cache, . . . , and last-level cache) with right tiling factors, match the register-level loops with efficient microkernels, order the tiled loops at the other levels, and parallelize some outermost loops such that data reuse and operation intensity are maximized and the many cores of a modern CPU (Central Processing Unit) are running in parallel. This process involves multiple loop transformations (e.g., loop tiling, permutation, collapsing, threading, etc.) and is complicated by an explosion of possible schedules and intricacies of modern architectures (e.g., multi-issue, prefetching, cache replacement policies, etc.). Identifying an efficient loop transformation sequence has been a perpetual challenge even to static compilers, let alone JIT compilers, which are limited by much less compile-time budget.

Polyhedral compilation and analytical models have been used for identifying an efficient loop transformation sequence. Polyhedral compilers formulate optimization models such as ILP (integer linear programming) models. Analytical models of caches are commonly built for important computations like matrix multiply and convolution to guide the selection of loop order and loop extents for the best cache performance. However, solving ILP problems can take too much time that is impractical for a JIT compiler. While coarse-grain analytical modeling can be effective, fine-grain accurate modeling of performance is very hard in practice due to modern architecture features like out-of-order execution and hardware prefetching.

Autotuning is another method that has been used for identifying loop transformation sequence. Autotuning can search the parameter space in various ways, such as hill combing, high variance sampling, and so on. Autotuning can also measure the results and identify the best values of the parameters. For example, Apache TVM accepts a tiled loop structure and a specification of a search space like permutations of a subset of loops, iterates through tiled loop configurations, generates and runs code on hardware, and measures performance. However, autotuning can take at least hours, and often days, which is not directly applicable for JIT compilation.

Additionally, AI (artificial intelligence) models with empirical search are also used for loop transformation. With an AI model with empirical search, the schedule space can be searched by, e.g., a tree where every node is a loop transform, and the AI model can be queried for predicted performance. Different search algorithms like beam search or Monte Carlo tree search can be applied. Various program features, including tensor references, operation counts, load/store bytes, etc. can be used to build up an AI model. However, the tradeoff between model size and accuracy is a challenge for JIT compilers. In a JIT environment, small models should be used for their fast execution but may lose accuracy. Therefore, improved technology for loop transformation in tensor compilers is needed.

Embodiments of the present disclosure may improve on at least some of the challenges and issues described above by using machine learning techniques to identify loop transformation sequences in tensor compilers, such as microkernel-based JIT tensor compilers. For instance, machine learning models can be used in the present disclosure to predict a performance of the processor in an execution of tensor computation and misses of memories used in the execution and use the predictions to evaluate loop transformation sequences and to select an optimal loop transformation sequence.

The present disclosure provides a tensor computing environment in which source code for tensor computation can be converted to an IR. The IR is a data structure that specifies tensor operations to be executed by an DNN (e.g., by one or more layers of the DNN). The IR includes a loop nest. The loop nest includes a plurality of loops. A loop indicates a tensor operation to be repeatedly executed. The number of times that tensor operation is to be repeatedly executed is the extent of the loop, which is also referred to as loop extent or extent. The tensor computing environment includes a tensor compiler that can use machine learning models to generate a schedule for the IR and use the schedule to transform loops in the loop nest. The schedule specifies a loop transformation sequence that includes one or more loop transformations.

The generation of the schedule by the tensor compiler may start with a search in a datastore that stores schedule trees for various IR categories. A schedule tree includes a plurality of schedules arranged based on their hierarchies. An IR category includes IRs having the same including the same tensor operation(s) and the same tensor references. But loop extents in the IRs of the same category may be different. The tensor compiler determines whether the IR falls under any of the IR categories. In embodiments where the IR falls into an IR category, the tensor compiler can generate a schedule tree for the IR based on one or more schedule trees of the IR category. In embodiments where the IR does not fall into an IR category, the tensor compiler can generate a schedule tree for the IR from scratch. In the generation of a schedule tree, the tensor compiler may use a first trained model to predict memory misses and determine loop extents based on the predicted memory misses.

After the schedule tree is generated, the tensor compiler uses a second trained model to select, from the schedule tree, an optimal schedule to be used for transforming the loop nest. The second trained model can predict performances of a processor executing the tensor computation based on IRs transformed with schedules. For each respective schedule in the schedule tree, the tensor compiler may input one or more parameters associated with the respective schedule into the trained model, and the trained model may output a performance score indicating an evaluation of a predicted performance of the processor. The tensor compiler may select the schedule that provides the best predicted performance of the processor. Further the tensor compiler transforms the loop nest with the selected schedule to generate an implementation. The tensor compiler may instruct the implementation so that runtime performance information of the processor can be provided to the tensor compiler after the processor executes the tensor computation. The tensor compiler may use the selected schedule and the runtime performance information to further train the second trained model.

By incorporating the machine learning models in the compiling process, the present disclosure provides an AI-assisted solution for transforming loops in microkernel-based JIT tensor compilers. The present disclosure can combine the power of analytical modeling, AI modeling, and on-demand recompilation to produce efficient loop transforms within limited time budget. Compared with conventional technologies for tensor compilers, the tensor compiler in the present disclosure is more advantageous. For instance, the tensor compiler in the present disclosure can take advantage of existing schedule trees of similar IRs by searching for schedule trees in the datastore. By using that machine learning models that can predict processor performance and memory misses, the tensor compiler can efficiently narrow down the schedule space in the process of generating schedule trees. The generated schedule trees can be fed back to the datastore to expand the pool of schedules for future searches. Also, the tensor compiler facilitates continuous training of the machine learning models, which can keep improving accuracy of the machine learning models.

For purposes of explanation, specific numbers, materials and configurations are set forth in order to provide a thorough understanding of the illustrative implementations. However, it will be apparent to one skilled in the art that the present disclosure may be practiced without the specific details or/and that the present disclosure may be practiced with only some of the described aspects. In other instances, well known features are omitted or simplified in order not to obscure the illustrative implementations.

Further, references are made to the accompanying drawings that form a part hereof, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicate that different instances of like objects are being referred to, and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value based on the input operand of a particular value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value based on the input operand of a particular value as described herein or as known in the art.

In addition, the terms “comprise,” “comprising,” “include,” “including,” “have,” “having” or any other variation thereof, are intended to cover a non-exclusive inclusion. For example, a method, process, device, or DNN accelerator that comprises a list of elements is not necessarily limited to only those elements but may include other elements not expressly listed or inherent to such method, process, device, or DNN accelerators. Also, the term “or” refers to an inclusive “or” and not to an exclusive “or.”

The DNN systems, methods and devices of this disclosure each have several innovative aspects, no single one of which is solely responsible for all desirable attributes disclosed herein. Details of one or more implementations of the subject matter described in this specification are set forth in the description below and the accompanying drawings.

### Example DNN

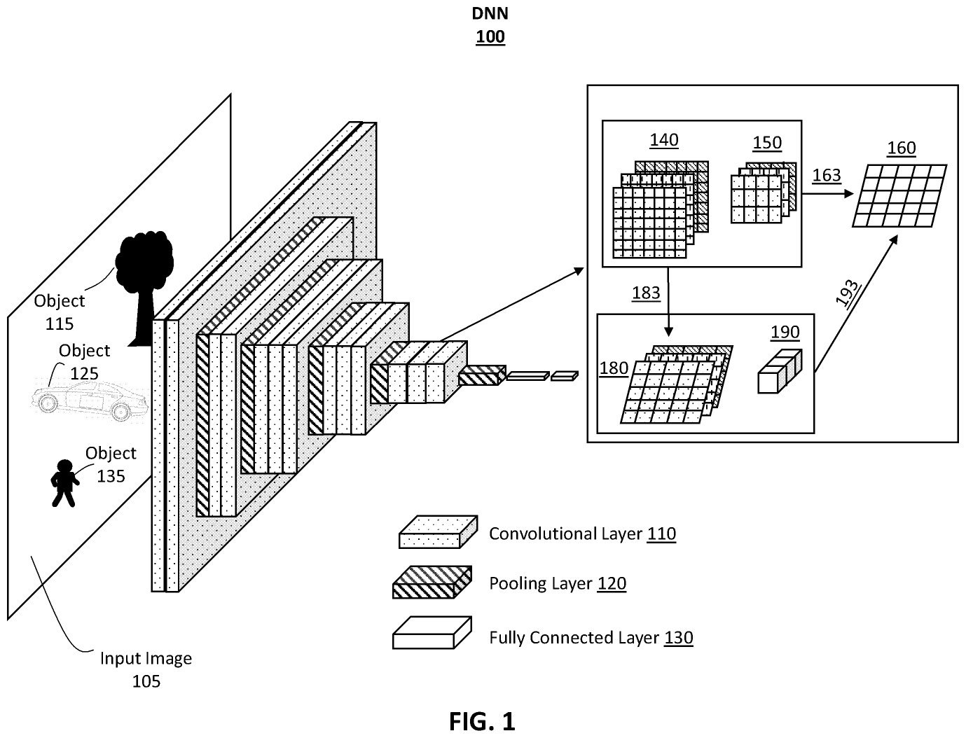

FIG. 1 illustrates an example DNN 100, in accordance with various embodiments. For purpose of illustration, the DNN 100 in FIG. 1 is a convolutional neural network (CNN). In other embodiments, the DNN 100 may be other types of DNNs. The DNN 100 is trained to receive images and output classifications of objects in the images. In the embodiments of FIG. 1, the DNN 100 receives an input image 105 that includes objects 115, 125, and 135. The DNN 100 includes a sequence of layers comprising a plurality of convolutional layers 110 (individually referred to as “convolutional layer 110”), a plurality of pooling layers 120 (individually referred to as “pooling layer 120”), and a plurality of fully connected layers 130 (individually referred to as “fully connected layer 130”). In other embodiments, the DNN 100 may include fewer, more, or different layers. In an inference of the DNN 100, the layers of the DNN 100 execute tensor computation that includes many tensor operations, such as convolution (e.g., multiply-accumulate (MAC) operations, etc.), pooling operations, elementwise operations (e.g., elementwise addition, elementwise multiplication, etc.), other types of tensor operations, or some combination thereof.

The convolutional layers 110 summarize the presence of features in the input image 105. The convolutional layers 110 function as feature extractors. The first layer of the DNN 100 is a convolutional layer 110. In an example, a convolutional layer 110 performs a convolution on an input tensor 140 (also referred to as input feature map (IFM) 140) and a filter 150. As shown in FIG. 1, the IFM 140 is represented by a 7×7×3 three-dimensional (3D) matrix. The IFM 140 includes three input channels, each of which is represented by a 7×7 two-dimensional (2D) array. The 7×7 2D array includes 7 input elements (also referred to as input points) in each row and 7 input elements in each column. The filter 150 is represented by a 3×3×3 3D matrix. The filter 150 includes three kernels, each of which may correspond to a different input channel of the IFM 140. A kernel a 2D array of weights, where the weights are arranged in columns and rows. A kernel can be smaller than the IFM. In the embodiments of FIG. 1, each kernel is represented by a 3×3 2D array. The 3×3 kernel includes 3 weights in each row and 3 weights in each column. Weights can be initialized and updated by backpropagation using gradient descent. The magnitudes of the weights can indicate importance of the filter 150 in extracting features from the IFM 140.

The convolution includes MAC operations with the input elements in the IFM 140 and the weights in the filter 150. The convolution may be a standard convolution 163 or a depthwise convolution 183. In the standard convolution 163, the whole filter 150 slides across the IFM 140. All the input channels are combined to produce an output tensor 160 (also referred to as OFM 160). The OFM 160 is represented by a 5×5 2D array. The 5×5 2D array includes 5 output elements (also referred to as output points) in each row and 5 output elements in each column. For purpose of illustration, the standard convolution includes one filter in the embodiments of FIG. 1. In embodiments where there are multiple filters, the standard convolution may produce multiple output channels in the OFM 160.

The multiplication applied between a kernel-sized patch of the IFM 140 and a kernel may be a dot product. A dot product is the elementwise multiplication between the kernel-sized patch of the IFM 140 and the corresponding kernel, which is then summed, always resulting in a single value. Because it results in a single value, the operation is often referred to as the “scalar product.” Using a kernel smaller than the IFM 140 is intentional as it allows the same kernel (set of weights) to be multiplied by the IFM 140 multiple times at different points on the IFM 140. Specifically, the kernel is applied systematically to each overlapping part or kernel-sized patch of the IFM 140, left to right, top to bottom. The result from multiplying the kernel with the IFM 140 one time is a single value. As the kernel is applied multiple times to the IFM 140, the multiplication result is a 2D array of output elements. As such, the 2D output array (i.e., the OFM 160) from the standard convolution 163 is referred to an OFM.

In the depthwise convolution 183, the input channels are not combined. Rather, MAC operations are performed on an individual input channel and an individual kernel and produce an output channel. As shown in FIG. 1, the depthwise convolution 183 produces a depthwise output tensor 180. The depthwise output tensor 180 is represented by a 5×5×3 3D matrix. The depthwise output tensor 180 includes three output channels, each of which is represented by a 5×5 2D array. The 5×5 2D array includes 5 output elements in each row and 5 output elements in each column. Each output channel is a result of MAC operations of an input channel of the IFM 140 and a kernel of the filter 150. For instance, the first output channel (patterned with dots) is a result of MAC operations of the first input channel (patterned with dots) and the first kernel (patterned with dots), the second output channel (patterned with horizontal strips) is a result of MAC operations of the second input channel (patterned with horizontal strips) and the second kernel (patterned with horizontal strips), and the third output channel (patterned with diagonal stripes) is a result of MAC operations of the third input channel (patterned with diagonal stripes) and the third kernel (patterned with diagonal stripes). In such a depthwise convolution, the number of input channels equals the number of output channels, and each output channel corresponds to a different input channel. The input channels and output channels are referred to collectively as depthwise channels. After the depthwise convolution, a pointwise convolution 193 is then performed on the depthwise output tensor 180 and a 1×1×3 tensor 190 to produce the OFM 160.

The OFM 160 is then passed to the next layer in the sequence. In some embodiments, the OFM 160 is passed through an activation function. An example activation function is the rectified linear activation function (ReLU). ReLU is a calculation that returns the value provided as input directly, or the value zero if the input is zero or less. The convolutional layer 110 may receive several images as input and calculates the convolution of each of them with each of the kernels. This process can be repeated several times. For instance, the OFM 160 is passed to the subsequent convolutional layer 110 (i.e., the convolutional layer 110 following the convolutional layer 110 generating the OFM 160 in the sequence). The subsequent convolutional layers 110 performs a convolution on the OFM 160 with new kernels and generates a new feature map. The new feature map may also be normalized and resized. The new feature map can be kernelled again by a further subsequent convolutional layer 110, and so on.

In some embodiments, a convolutional layer 110 has four hyperparameters: the number of kernels, the size F kernels (e.g., a kernel is of dimensions F×F×D pixels), the S step with which the window corresponding to the kernel is dragged on the image (e.g., a step of one means moving the window one pixel at a time), and the zero-padding P (e.g., adding a black contour of P pixels thickness to the input image of the convolutional layer 110). The convolutional layers 110 may perform various types of convolutions, such as 2-dimensional convolution, dilated or atrous convolution, spatial separable convolution, depthwise separable convolution, transposed convolution, and so on. The DNN 100 includes 16 convolutional layers 110. In other embodiments, the DNN 100 may include a different number of convolutional layers.

The pooling layers 120 down-sample feature maps generated by the convolutional layers, e.g., by summarizing the presents of features in the patches of the feature maps. A pooling layer 120 is placed between two convolution layers 110: a preceding convolutional layer 110 (the convolution layer 110 preceding the pooling layer 120 in the sequence of layers) and a subsequent convolutional layer 110 (the convolution layer 110 subsequent to the pooling layer 120 in the sequence of layers). In some embodiments, a pooling layer 120 is added after a convolutional layer 110, e.g., after an activation function (e.g., ReLU) has been applied to the OFM 160.

A pooling layer 120 receives feature maps generated by the preceding convolution layer 110 and applies a pooling operation to the feature maps. The pooling operation reduces the size of the feature maps while preserving their important characteristics. Accordingly, the pooling operation improves the efficiency of the DNN and avoids over-learning. The pooling layers 120 may perform the pooling operation through average pooling (calculating the average value for each patch on the feature map), max pooling (calculating the maximum value for each patch of the feature map), or a combination of both. The size of the pooling operation is smaller than the size of the feature maps. In various embodiments, the pooling operation is 2×2 pixels applied with a stride of two pixels, so that the pooling operation reduces the size of a feature map by a factor of 2, e.g., the number of pixels or values in the feature map is reduced to one quarter the size. In an example, a pooling layer 120 applied to a feature map of 6×6 results in an output pooled feature map of 3×3. The output of the pooling layer 120 is inputted into the subsequent convolution layer 110 for further feature extraction. In some embodiments, the pooling layer 120 operates upon each feature map separately to create a new set of the same number of pooled feature maps.

The fully connected layers 130 are the last layers of the DNN. The fully connected layers 130 may be convolutional or not. The fully connected layers 130 receives an input operand. The input operand defines the output of the convolutional layers 110 and pooling layers 120 and includes the values of the last feature map generated by the last pooling layer 120 in the sequence. The fully connected layers 130 applies a linear combination and an activation function to the input operand and generates an individual partial sum. The individual partial sum may contain as many elements as there are classes: element i represents the probability that the image belongs to class i. Each element is therefore between 0 and 1, and the sum of all is worth one. These probabilities are calculated by the last fully connected layer 130 by using a logistic function (binary classification) or a softmax function (multi-class classification) as an activation function.

In some embodiments, the fully connected layers 130 classify the input image 105 and returns an operand of size N, where N is the number of classes in the image classification problem. In the embodiments of FIG. 1, N equals 3, as there are three objects 115, 125, and 135 in the input image. Each element of the operand indicates the probability for the input image 105 to belong to a class. To calculate the probabilities, the fully connected layers 130 multiply each input element by weight, makes the sum, and then applies an activation function (e.g., logistic if N=2, softmax if N>2). This is equivalent to multiplying the input operand by the matrix containing the weights. In an example, the individual partial sum includes three probabilities: a first probability indicating the object 115 being a tree, a second probability indicating the object 125 being a car, and a third probability indicating the object 135 being a person. In other embodiments where the input image 105 includes different objects or a different number of objects, the individual partial sum can be different.

### Example Tensor Computation Environment

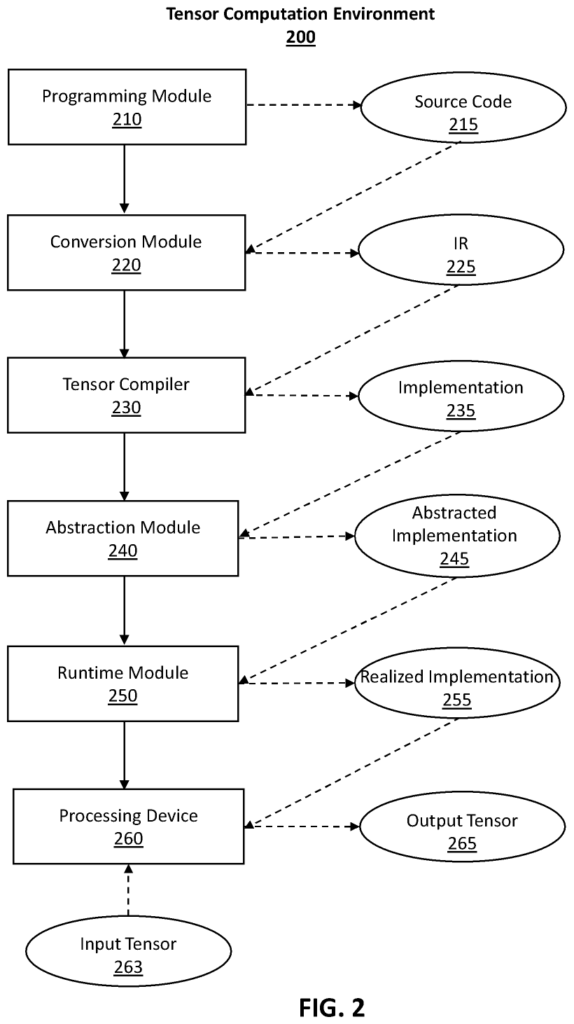

FIG. 2 illustrates a tensor computation environment 200, in accordance with various embodiments. The tensor computation environment 200 provides an environment where tensor computation in some or all layers of a DNN, such as the DNN 100 in FIG. 1, can be performed. Tensor computation may include convolution, pooling operation, elementwise operation (e.g., elementwise addition, elementwise multiplication, etc.), loading, reducing, other types of tensor operations by the DNN, or some combination thereof. As shown in FIG. 2, the tensor computation environment 200 includes a programming module 210, a conversion module 220, a tensor compiler 230, an abstraction module 240, a runtime module 250, and a processor 260. The programming module 210, a conversion module 220, a tensor compiler 230, and an abstraction module 240 may be at least partially implemented in software. The processor 260 may be at least partially implemented in hardware. In other embodiments, alternative configurations, different or additional components may be included in the tensor computation environment 200. Further, functionality attributed to a component of the tensor computation environment 200 may be accomplished by a different component included in the tensor computation environment 200 or by a different system.

The programming module 210 facilitates generation of source code 215. The source code 215 is a set of computer program instructions in a human-readable form. The computer instructions are to be executed by the processor 260 to perform tensor computation. In some embodiments, the source code 215 is written in a high-level programming language, such as C, C++, Java, Python, and so on. The source code 215 cannot be executed by the processing device directly and needs to be converted to machine code that is executable by the processing device.

In an embodiment, the programming module 210 provides a programming environment in which users can write computer program instructions in one or more programming languages. The programming languages supported by the programming module 210 may be a human-readable programming language, such as C, C++, Java, Python, and so on. In another embodiment, the programming module 210 may receive the source code 215 from another system or device. For example, the programming module 210 may retrieve the source code 215 from a library of a deep learning framework. As another example, the programming module 210 may retrieve the source code 215 from a memory associated with the DNN. As yet another example, the programming module 210 may retrieve the source code 215 from a computer device in communication with the programming module 210.

The conversion module 220 receives the source code 215 and converts the source code 215 to an IR 225. The IR 225 is a data structure that represents the source code 215. The IR 225 includes a loop nest indicating one or more tensor operations to be repeatedly executed by the processor 260. The loop nest includes a sequence of loops where a loop is inside of one or more other loops that are subsequent to the loop in the sequence. The first loop in the sequence may be the inner most loop, and the last loop in the sequence may be the outer most loop. A loop may include a sequence of programming instructions that is specified once but may be carried out multiple times in succession. A loop may indicate a tensor operation to be repeatedly executed by the processor 260. The number of times that the tensor operation is to be executed is the extent of the loop. A loop having an extent equal to 1 is a unity loop. The tensor operations may be for tensors of same dimensions.

The IR 225 may include information indicating attributes of the loop nest. The attributes of the loop nest may include the tensor operation to be repeatedly executed, tensor references, loop extents, other attributes of the loop nest, or some combination thereof. The tensor operation may be convolution, pooling operation, elementwise operation, reducing tensor, loading tensor, other tensor operations, or some combination thereof. The tensor references may include tensor rank (i.e., the number of dimension(s) of the tensor, e.g., 1, 2, 3, etc.), tensor shape (i.e., the number of elements in each dimension of the tensor), tensor length (the total number of elements in the tensor), other tensor references, or some combination thereof. The IR 225 may include code indicating other attributes of the loop nest.

The IR 225 is to be conductive to further processing, such as loop transformation. The IR 225 may have a data structure form, such as an in-memory data structure, special tuple-based code, stack-based code, or other forms. Compared with the source code 215, the IR 225 may have a form that is more suitable for code-improving transformations before being used to generated machine code for a target device, e.g., the processing device. The conversion module 220 may be part of a programming framework, such as Keras, TensorFlow, OpenVino, and so on.

The tensor compiler 230 receives the IR 225 and optimizes the IR 225. For instance, the tensor compiler 230 can optimize the IR 225 by transforming the loop nest in the IR 225. The tensor compiler 230 may perform various types of loop transformation, such as loop permutation, index rewriting, loop unrolling, loop splitting, loop tiling, loop padding, other types of loop transformation, or some combination thereof. Loop permutation can change the order of loops in a loop nest. Index rewriting can change the way the loop indexes are expressed. Loop unrolling can create one or more copies of a loop body and modifies the loop indexes appropriately. Loop splitting can divide a loop with multiple operations to multiple separate loops, each operation corresponds to a different one of the separate loops. Loop fusion can fuse multiple loops into one loop, and the new loop incorporates the operations of the multiple loops. Loop tiling can split a loop into a nest of loops, with each inner loop working on a small block of the data of the original loop. Loop padding can add data elements to an array to change how the array maps into the memory system structure. Loop transformation can increase execution speed and reduce overheads associated with loops. Optimization through loop transformation can improve cache performance and making effective use of parallel processing capabilities.

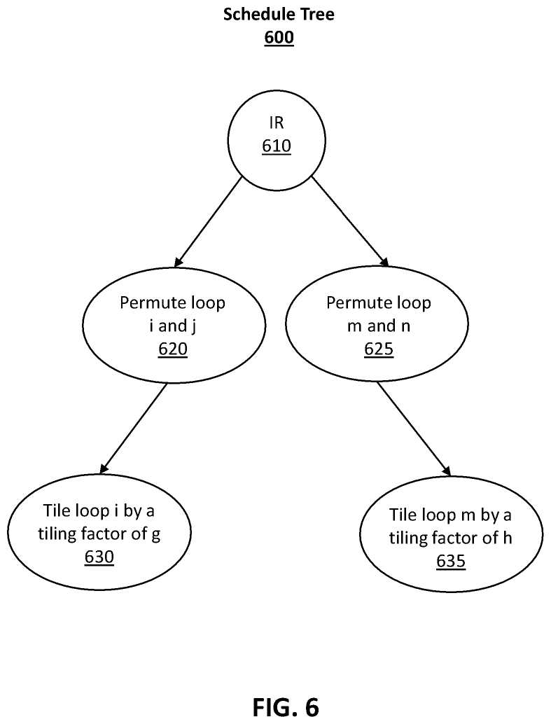

The tensor compiler 230 may use a schedule to transform the loop nest. A schedule may specify a sequence of loop transformations. In some embodiments, the tensor compiler 230 generates a schedule tree for the loop nest. The schedule tree includes schedules arranged based on their hierarchies. The schedule tree includes a root, which has the highest hierarchy. The root may be the IR 225. The root can be the parent of one or more nodes, which have the second highest hierarchy. A node in the second level can be a parent of one or more nodes in the third level. The schedule tree may have two or more levels. Every node in the schedule tree is a schedule. More details regarding schedule tree are described below in conjunction with FIG. 6.

In some embodiments, the tensor compiler 230 maintains, e.g., through caching, a database including schedule trees that have been generated or used for previous IRs. Deep learning is an important application domain of the tensor compiler 230. Many DNNs include similar or even same layers that perform same tensor operations. The tensor compiler 230 can run a similarity search in the database to determine whether the IR is the same as or similar to any of the previous IRs. In embodiments where the tensor compiler 230 finds a matching (i.e., same or similar) IR in the database, the tensor compiler 230 can use the already-created schedule trees of the matching IR to generate the schedule tree of the IR, which can be more time and resource efficient than generating the schedule tree from scratch.

After the tensor compiler 230 generates the schedule tree, the tensor compiler 230 selects, from the schedule tree, a schedule that can trigger the best predicted performance of the processor 260 in the execution of the tensor operations. The tensor compiler 230 may use a trained model to predict performance of the processor 260. The tensor compiler 230 can use the schedule to transform the loop nest. In embodiments where the schedule is in the third or even lower level, one or more other schedules, which are ancestor(s) (e.g., parent, grandparent, great grandparent, etc.) of the selected schedule in the schedule tree, are also used to transform the loop nest. The schedule and the one or more other schedules constitute a sequence of schedules that specifies a sequence of loop transformations.

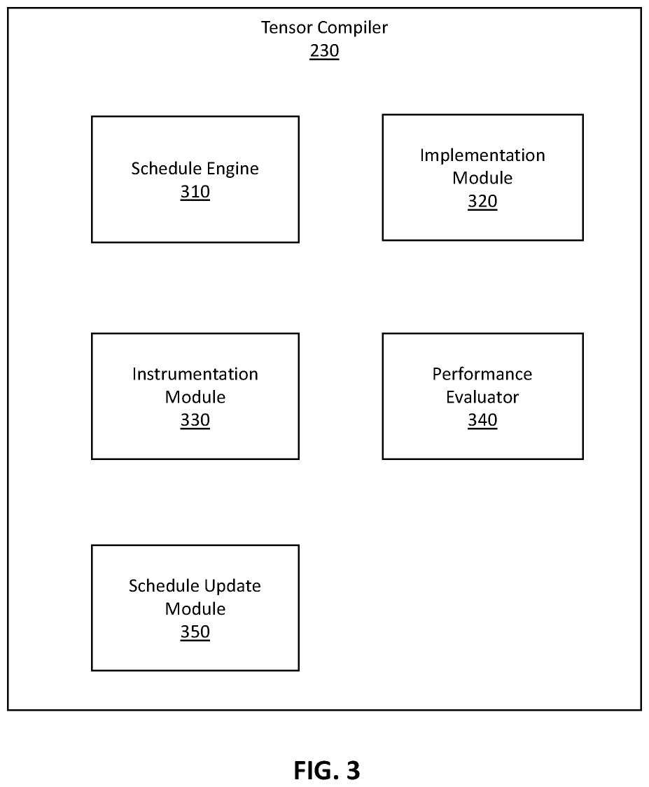

After the tensor compiler 230 selects the schedule, the tensor compiler 230 implements the schedule (or the schedule plus one or more ancestors of the schedule) to transform the loop nest. The result of the transformation is an implementation 235. In some embodiments, the tensor compiler 230 also instruments the implementations 235 so that when the implementation 235 runs on the processor 260, information indicating a performance of the processor 260 can be generated and provide to the tensor compiler 230, e.g., from the runtime module 250. The tensor compiler 230 can use the performance information to determine a runtime performance score that indicates an evaluation of the runtime performance of the processor 260 in the execution of the tensor operations with the implementation 235. The selected schedule and the runtime performance score can be used to further train the trained model. As the tensor compiler 230 continuously select schedules and determines runtime performance scores for the schedules, the tensor compiler 230 can continuously train the trained model. More details regarding the tensor compiler 230 are described below in conjunction with FIGS. 3-5.

The abstraction module 240 is between the tensor compiler 230 and the processor 260. The abstraction module 240 allows the tensor compiler 230 to interact with the processor 260 at a general and abstract level, as opposed to a detailed hardware level. The abstraction module 240 may include a hardware abstraction layer. The abstraction module 240 converts the implementation 235 to an abstracted implementation 245. In some embodiments, the abstraction module 240 may replace one or more loops in the implementation 235 with microkernels in the abstracted implementation 245. For instance, the abstraction module 240 can replace one or more loops at the innermost level of the loop nest with microkernels. Loops at the innermost level may be loops corresponding to the memory of the highest hierarchy, such as registers of the processor 260. The microkernels may be virtual instructions. The abstraction module 240 can hide differences in hardware of the processor 260 so that the code does not need to be changed to run on processing devices with different hardware.

The runtime module 250 facilitates the execution of the tensor operations by the processor 260 and provides an environment in which the abstract implementation 245 runs. Runtime refers to the period during which the processor 260 executes the tensor operations. The runtime module 250 may address a number of issues related to the execution of the tensor operations by the processor 260, e.g., management of memory, access of variables, interfacing with operating system, and so on. The runtime module 250 may realize the microkernels in the abstracted implementation 245 and generates realized implementation 255 that can be executed by the processing device 360. The realized implementation 255 may be machine code. In some embodiments, the runtime module 250 includes a library.

The processor 260 executes, in accordance with the realized implementation 255, the tensor operations on an input tensor 263 and generates an output tensor 265. An example of the input tensor 263 is the IFM 140 in FIG. 1. An example of the output tensor 265 is the OFM 160 in FIG. 1. The processor 260 may constitute one or more layers of a DNN, an example of which is the DNN 100 in FIG. 1. The processor 260 includes hardware components that can execute tensor computation. In an embodiment, the processor 260 includes a plurality of processing elements that can perform MAC operations, pooling operations, elementwise operations, other types of deep learning operations, or some combination thereof. The processing elements may be arranged in one or more tiles. Each tile may include an array of processing elements, in which the processing elements are arranged in rows and columns. The processor 260 may also include one or more memories, such as registers, cache memories (e.g., L0 cache, L1 cache, L2 cache, etc.). Data used or generated by the processor 260, such as input tensor 263 and the output tensor 265, may be stored in some or all of the memories. Even though FIG. 2 shows one processor, the tensor computation environment 200 may include multiple processors in other embodiments.

### Example Tensor Compiler

FIG. 3 is a block diagram of the tensor compiler 230, in accordance with various embodiments. The tensor compiler 230 may be a JIT compiler, such as a microkernel-based JIT compiler, and can quickly obtain schedules for transforming loop. As shown in FIG. 3, the tensor compiler 230 includes a schedule engine 310, an implementation module 320, an instrumentation module 330, a performance evaluator 340, and a schedule update module 350. In other embodiments, alternative configurations, different or additional components may be included in the tensor compiler 230. Further, functionality attributed to a component of the tensor compiler 230 may be accomplished by a different component included in the tensor compiler 230 or by a different system.

The schedule engine 310 generates schedule trees for IRs. The schedule engine 310 may start the generator of a schedule tree for an IR with a search in a schedule database. The schedule database includes schedule trees that are associated with one or more IR categories. An IR category includes IRs having the same including the same tensor operation(s) and the same tensor references. But loop extents in the IRs of the same category may be different. The schedule engine 310 determines whether the IR falls into any of the IR categories in the schedule database. In response to determining that the IR falls into an IR category, the schedule engine 310 retrieves the one or more schedule trees associated with the IR category and uses these schedule trees to generate a schedule tree for the IR. The schedule engine 310 may merge the schedule trees into one merged tree. The schedule engine 310 may also modify the merged tree to obtain the schedule tree for the IR.

In response to determining that the IR does not fall into any IR category in the database, the schedule engine 310 may generate the schedule tree of the IR from scratch. The schedule engine 310 may partition the loop nest in the IR into multiple loop nests, e.g., through permutation. Each of the multiple loop nests corresponds to a different memory level. For instance, the multiple loops nests may include a register loop nest, a L1 cache loop nest, a L2 cache loop nest . . . , a last-level cache loop nest, and a main-memory loop nest. The schedule engine 310 may further modify each of the loop nests, e.g., by changing the order of the loops in a loop nest, adjusting extents of the loops in a loop nest, or a combination of both. The schedule engine 310 can generate the schedule tree based on the permutation and the adjusted loop extents.

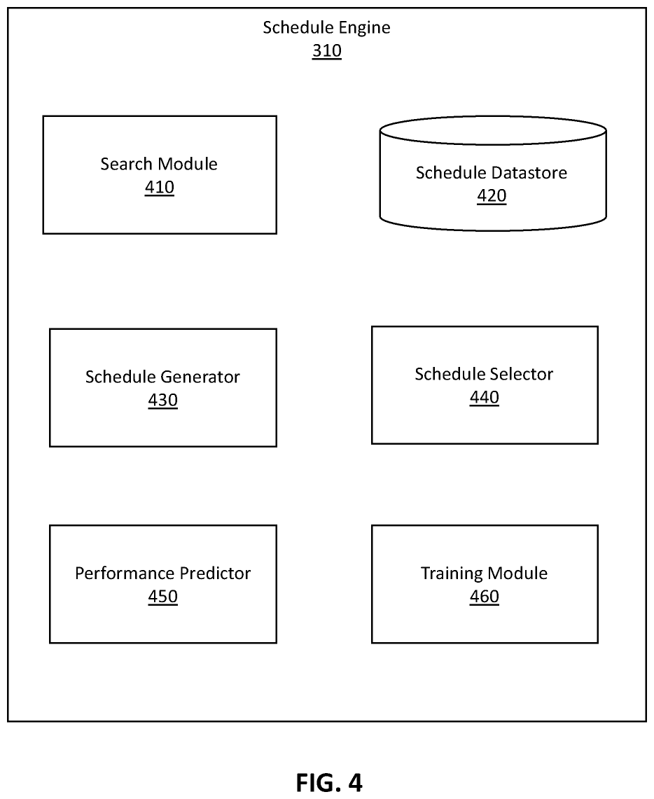

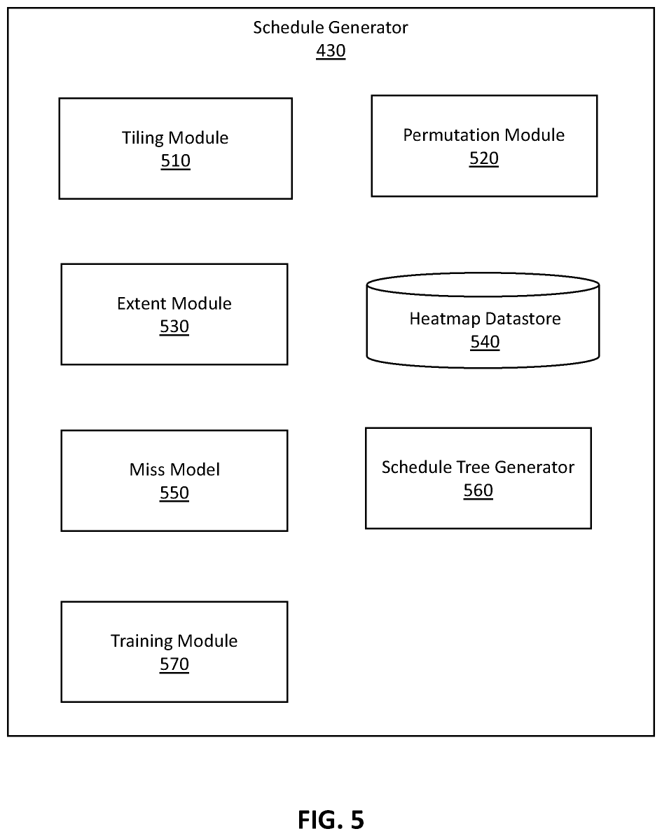

The schedule engine 310 further selects a schedule from the schedule tree. To select the schedule, the schedule engine 310 may determine predicted performance scores for all the schedules in the schedule tree and select the schedule having the highest predicted performance score. For instance, for each schedule in the schedule tree, the schedule engine 310 determines attributes of the loop nest after the loop nest is transformed with the schedule and inputs the attributes into a trained model. The trained model outputs a predicted performance score that indicates an evaluation of a predicted performance of the processor 260 in an execution of the tensor operations with the IR 225 compiled with the schedule. More details regarding the schedule engine 310 are described below in conjunction with FIGS. 4 and 5.

The implementation module 320 transforms the loop nest in the IR in accordance with the schedule obtained by the schedule engine 310. The loop transformation can improve performance of the processor 260 in executing the tensor operations. For instance, the loop transformation can increase execution speed of the processor 260 so that the execution time is reduced. It can also reduce the overheads associated with the loops and make effective use of parallel processing capabilities. It also plays an important role in improving performance of memories, such as registers and cache memory. Through the transformation, the implementation module 320 generates an implementation, e.g., the implementation 235.

The instrumentation module 330 instruments the implementation generated by the implementation module 320 to facilitate generation of performance information. In some embodiments, the instrumentation module 330 adds one or more instructions in the implementation 235. The instructions, when executed by the processor 260, cause information indicating performance of the processor 260 in the execution of the tensor computation to be sent to the tensor compiler 230, e.g., to the performance evaluator 340. The performance information may include information indicating the time that the processor 260 took to execute the tensor computation, information indicating memory misses (e.g., cache misses, other information indicating the performance of the processor 260, or some combination thereof. The performance information may be runtime performance information, which can be provided by the runtime module 250.

The performance evaluator 340 uses the performance information to evaluate performance of the processor 260 in execution of tensor operations. The performance evaluator 340 may determine a runtime performance score indicating the runtime performance of the processor 260 in the execution. In some embodiments, the performance evaluator 340 may determine the runtime performance score by aggregating one or more scores. The one or more scores may indicate one or more of the execution speeds of the processor 260, memory misses, utilization of memories, and so on. A score may have a weight. The runtime performance score may be a weighted aggregation (e.g., weighted sum or average) of the scores. The performance evaluator 340 may also compare the runtime performance score with the predicted performance score for the schedule. In embodiments where a difference between the runtime performance score and the predicted performance score is beyond a threshold, the performance evaluator 340 may request for further training of the trained model (e.g., the performance predictor 450) and can provide the runtime performance score and the schedule to a training module (e.g., the training module 460) to further train the trained model.

In some embodiments (such as embodiments where the schedule engine 310 generates a schedule tree based on memory misses predicted by a trained model), the performance evaluator 340 may also determine a runtime miss score indicating the runtime memory misses in the execution. In some embodiments, the performance evaluator 340 may determine the runtime miss score by aggregating one or more memory miss scores. A memory miss score may indicate misses of a memory associated with the processor 260. The schedule engine 310 may assign different weights to different memories (e.g., the weight for L1 cache may be higher than the weight for L2 cache) and determine a weighted aggregation (e.g., weighted sum or average) of the memory miss scores. The performance evaluator 340 may also compare the runtime miss score with the predicted miss score for the schedule. In embodiments where a difference between the runtime miss score and the predicted miss score is beyond a threshold, the performance evaluator 340 may request for further training of the trained model and can provide the runtime miss score and the schedule to a training module (e.g., the training module 570) to further train the trained model.

The schedule update module 350 may change the schedule selected by the schedule engine 310 for the IR to a different schedule. In some embodiment (such as embodiments where the trained model is further trained), the schedule update module 350 may use the further trained model to select a different schedule from the schedule tree. The schedule update module 350 may also request the implementation module 320 to use the different schedule to transform the loop nest and to generate a different implementation. The processor 260 may use the different implementation to execute tensor operations in future tensor computation. The re-selection by the schedule update module 350 may be beneficial, especially for inference workloads that repeat for a large number of times. It is worthwhile to choose and implement a better schedule, if the current schedule is no longer predicted as the best. Over time, the IR can be optimized with better and better efficiency.

FIG. 4 is a block diagram of the schedule engine 310, in accordance with various embodiments. The schedule engine 310 includes a search module 410, a schedule datastore 420, a schedule generator 430, a schedule selector 440, a performance predictor 450, and a training module 460. In other embodiments, alternative configurations, different or additional components may be included in the schedule engine 310. Further, functionality attributed to a component of the schedule engine 310 may be accomplished by a different component included in the schedule engine 310 or by a different system.

The search module 410 searches for schedules that can be used for a target IR in a schedule datastore 420. An example of the target IR is the IR 225 in FIG. 2. The schedule datastore 420 stores a plurality of IR categories. An IR category is a category of IRs including the same tensor operation and the same tensor reference. But loop extents in the IRs of the same category may be different. Each IR category in the schedule datastore 420 corresponds to one or more schedule trees, which are also stored in the schedule datastore 420. A schedule tree for an IR category may be a schedule tree that has been used (or has been proved to be valid) to optimize an IR in the IR category.

The search module 410 determines whether the target IR falls into any of the IR categories in the schedule datastore 420. For instance, the search module 410 determines the tensor operation and tensor references in the target IR. The search module 410 then determines whether the tensor operation and tensor references in the target IR match the tensor operation and tensor references in any of the IR categories. The search module 410 determines that the target IR fall into an IR category in response to determining that the tensor operation in the target IR matches the tensor operation and tensor references in the IR category.

Further, the search module 410 retrieves the schedule trees of the IR category and generate a schedule tree for the target IR based on the retrieved schedule trees. In some embodiments, the search module 410 uses all the retrieved schedule trees as candidate schedule trees of the target IR. In other embodiments, the search module 410 uses a subset of the retrieved schedule trees as candidate schedule trees of the target IR. For instance, the search module 410 may determine a similarity score that indicates an extent of similarity between the target IR and the IR of a retrieved schedule tree, e.g., based on a comparison of one or more loop extents in the target IR with one or more corresponding loop extents in the IR. In response to determining that the similarity score is below a threshold similarity score or below similarity scores of some or all the other retrieved schedule trees, the search module 410 may remove the schedule tree and use the other retrieved schedule trees as candidate schedule trees of the target IR.

In some embodiments (e.g., embodiments where the search module 410 obtains multiple candidate schedule trees for the target IR), the search module 410 merges the candidate schedule trees to a merged schedule tree of the target IR. The search module 410 may make the target IR as the root of the merged schedule tree and make each candidate schedule tree a branch of the root. The target IR and each candidate schedule tree has a parent-child relationship. Within an individual candidate schedule tree that includes multiple schedules, these schedules may have parent-child relationship or sibling relationship. The search module 410 may assign different priorities to the candidate schedule trees based on the similarity scores of the candidate schedule trees. A candidate schedule tree having a higher similarity score (i.e., the IR of the candidate schedule tree is more similar to the target IR) can have a higher priority in the merged schedule tree.

After the candidate schedule trees are merged, the search module 410 may modify or remove incompatible schedules in the merged schedule tree. For instance, the search module 410 may identify a schedule for loop tiling and determine whether the tiling factors of the schedule is compatible with the target IR, e.g., by determining whether the result of dividing the loop sizes in the target IR with the tiling factors are integers. The search module 410 may identify the schedule based on a determination that IR of the schedule is not the same as the target IR, e.g., the loop sizes of the IR are different from the loop sizes of the target IR. In response to determine that the tiling factors of the schedule are incompatible with the target IR (e.g., some results of the division are not integers), the search module 410 may remove the schedule from the merged schedule tree.

Alternatively, the search module 410 may modify one or more loops that are incompatible with the schedule. For instance, the search module 410 adjust the tiling factor of an incompatible loop to make the loop tiling compatible with the loop, e.g., to make the result of dividing the loop extent by the tiling factor an integer. In some embodiments such as embodiments where the loop tiling schedule is incompatible with multiple loops, the search module 410 may modify multiple loops in the loop nest. The search module 410 may start with the innermost loop. The innermost tiled loop may be a loop corresponding to the highest memory hierarchy, e.g., registers. The search module 410 may determine a suitable loop extent for the innermost tiled loop under consideration, such that the register-level microkernel(s) performance can be kept the best. Next, the search module 410 may determine a suitable extent for a L1 cache tiled loop under consideration, such that the L1 cache misses are minimized, and so on. The modification process might use the heatmap and cache miss predictors described below. After the incompatible schedule(s) (if any) is modified or removed, the search module 410 can output the schedule tree of the target IR.

In embodiments where the search module 410 determines that the target IR does not fall into any of the IR categories in the schedule datastore 420, the search module 410 may request the schedule generator 430 to generate a schedule tree for the target IR from scratch. The schedule generator 430 may generate the schedule tree starting with loop tiling. For instance, the schedule generator 430 partitions a loop nest in the target IR into multiple memory loop nests for all the memories associated with the processor 260. Each memory loop nest corresponds to a different memory. For a memory loop nest, the schedule generator 430 may determine one or more permutations for changing the order of the loops in the memory loop nest and determine extents of the loops. Then the schedule generator 430 can generate a schedule tree based on the permutations and loop extents.

After the schedule generator 430 generates the schedule tree for the target IR, the schedule generator 430 can also create a new IR category and store the new IR category and the schedule tree in the schedule datastore 420. The IR category has the same tensor operations and tensor references as the target IR. However, different from the target IR having a loop extent of a specific number, the corresponding loop extent of the IR category is a range that includes the specific number. For instance, a loop extent in the target IR is 16, but the IR category covers IRs having loop extents in the range from 1 to 64. More details regarding the schedule generator 430 are described below in conjunction with FIG. 5.

The schedule selector 440 selects a schedule from the schedule tree for the target IR. The schedule is to be used to transform the loop nest in the target IR. In some embodiments, the schedule selector 440 selects the schedule based on predicted performances of the processor 260 executing the tensor computation based on the schedules in the schedule tree. For instance, the schedule selector 440 determines a performance score for a schedule. The performance score indicates a predicted performances of the processor 260 executing the tensor computation based on the schedule. The schedule selector 440 can rank the schedules based on the performance scores and select the schedule having the highest ranking, i.e., the schedule that can trigger the best performance of the processor 260.

The schedule selector 440 can determine performance scores by using the performance predictor 450. The performance predictor 450 is a model that has been trained to receive one or more attributes of IRs after being transformed with schedules and outputs performance scores for the schedules. The attributes include loop extents, tensor references, tensor operations, other attributes, or some combination thereof. The schedule selector 440 can input one or more attributes of the IR 225 after being transformed by each respective schedule in the schedule tree. The schedule selector 440 then receives a performance score for each respective schedule from the performance predictor 450.

The training module 460 trains the performance predictor 450. The training module 460 applies machine learning techniques to generate the performance predictor 450 that when applied to attributes of an IR being transformed with a schedule outputs a performance score indicating a predicted performance of the processor 260 executing tensor computation based on the IR. As part of the generation of the performance predictor 450, the training module 460 may form a training set. A training set includes training samples and ground-truth labels of the training samples. A training sample may include one or more attributes of an IR being transformed with a schedule. The training sample may have a ground-truth performance score, the performance score may be a known performance score or a performance score that has been verified. The training module 460 extracts feature values from the training set, the features being variables deemed potentially relevant to memory misses. An ordered list of the features may be a feature vector. In one embodiment, the training module 460 applies dimensionality reduction (e.g., via linear discriminant analysis (LDA), principle component analysis (PCA), or the like) to reduce the amount of data in the feature vectors to a smaller, more representative set of data.

The training module 460 may use supervised machine learning to train the performance predictor 450, e.g., with the feature vectors of the training set. Different machine learning techniques—such as linear support vector machine (linear SVM), boosting for other algorithms (e.g., AdaBoost), neutral networks, logistic regression, naïve Bayes, memory-based learning, random forests, bagged trees, decision trees, boosted trees, or boosted stumps—may be used in different embodiments.

In some embodiments, a validation set is formed of data associated with additional IRs and additional schedules, other than those in the training sets, which have known or verified performance scores. The training module 460 applies the trained performance predictor 450 to the additional IRs and schedules of the validation set to quantify the accuracy of the performance predictor 450. The accuracy may be determined based on differences between performance scores determined by the performance predictor 450 and the known or verified performance scores. In one embodiment, the training module 460 iteratively re-trains the performance predictor 450 until the occurrence of a stopping condition, such as the accuracy measurement indication that the model is sufficiently accurate, or a number of training rounds having taken place.

In some embodiments, the training module 460 continuously trains a part of or the whole performance predictor 450. For instance, after the training module 460 trains the performance predictor 450, the performance predictor 450 receives attributes of a memory loop nest and outputs a performance score. The training module 460 may receive performance information after the processor 260 executes the tensor computation based on the memory loop nest. The training module 460 can determine a runtime performance score based on the performance information. The runtime performance score indicates the real memory misses during the execution of the tensor computation. The training module 460 uses the memory loop nest and the run time performance score as a new training sample to further train the performance predictor 450. The training module 460 can continuously generate new training sets and re-train the performance predictor 450 as it receives more performance information and determines more runtime performance scores.

FIG. 5 is a block diagram of the schedule generator 430, in accordance with various embodiments. As described above, the schedule generator 430 generates a schedule tree for a target IR. The schedule generator 430 includes a tiling module 510, a permutation module 520, an extent module 530, a heatmap datastore 540, a miss model 550, a schedule tree generator 560, and a training module 570. In other embodiments, alternative configurations, different or additional components may be included in the schedule generator 430. Further, functionality attributed to a component of the schedule generator 430 may be accomplished by a different component included in the schedule generator 430 or by a different system.

The tiling module 510 identifies a loop nest in the target IR and partitions the loop nest into multiple loop nests through loop tiling. In some embodiments, the tiling module 510 may tile each loop in the loop nest into separate loops based on memory levels associated with the processor 260. The memory levels may include registers, L1 cache, L2 cache . . . , and the last level cache. Each of the separate loops corresponds to a different memory level. For instance, a loop is split to a register loop, a L1 cache loop, a L2 cache loop, . . . , and a last-level cache loop. After the loop tiling, there will be multiple loop nests, each of which corresponds to a different memory level and has N memory loops.

In an example, the loop nest includes n loops: i₁, i₂, . . . iₙ, where n is an integer that is larger than 2. The processor 260 is associated with four memory levels: registers, L1 cache, L2 cache, L3 cache, and main storage (e.g., DRAM (dynamic random-access memory), where the L3 cache is the last-level cache. The tiling module 510 splits each of the n loops into five memory loops, each of which corresponds to one of the five memory levels. As a result, the tiling module 510 generates five memory loop nests. The first memory loop nest is for the registers and includes n loops: i_{1Register}, i_{2Register}, . . . i_{nRegister}. The second memory loop nest is for the L1 cache and includes n loops: i_{1L1}, i_{2L1}, . . . i_{nL1}. The third memory loop nest is for the L2 cache and includes n loops: i_{1L2}, i_{2L2}, . . . i_{nL2}. The fourth memory loop nest is for the L3 cache and includes n loops: i_{1L3}, i_{2L3}, . . . i_{nL3}. The fifth memory loop nest is for the main memory and includes n loops: i_{1Mem}, i_{2Mem}, . . . i_{nMem}. The loops i_{1Register}, i_{1L1}, i_{1L2}, i_{1L3}, and i_{1Mem} are generated by partitioning the loop i₁. Similarly, the loops i_{2Register}, i_{2L1}, i_{2L2}, i_{2L3}, and i_{2Mem} are generated by partitioning the loop i₂, and the loops i_{nRegister}, i_{nL1}, i_{nL2}, i_{nL3}, and i_{nMem} are generated by partitioning the loop iₙ.

The permutation module 520 adjusts orders of the memory loops in one or more memory loop nests. For a particular memory level, the permutation module 520 determines one or more loop permutations and uses the determined one or more loop permutations to change the order of the memory loops in the corresponding memory loop nest to minimize data movement to and from the memory. The permutation module 520 may generate the one or more loop permutations by using an analytical model technique. In some embodiments, the permutation module 520 does not adjust the orders of all the memory loop nests. For instance, the permutation module 520 may determine not to adjust the order of the register loops in the register loop nest. The register loops are at the innermost level, and these loops and the loop body must match one or more microkernels. The permutation module 520 may determine that the order of the register loops does not need to be adjusted because the register loops will be replaced by the microkernels anyway.

The extent module 530 determines one or more sets of loop extents for each memory loop nest. The extent module 530 may process the memory loop nests in an order determined based on the hierarchies of the memories, e.g., from the memory having the highest hierarchy to the memory having the lowest hierarchy. For instance, the extent module 530 may first determines loop extents for the registers, then determines loop extents for L1 cache, followed by L2 cache, all the way to the last-level cache. In some embodiments, the extent module 530 determines an optimal set of loop extents for the register loop nest. For instance, for a brgemm (batch-reduced general matrix multiply) microkernel in TPP (Tensor Processing Primitives), a loop extent set (bc, bk)=(32, 24) could yield an optimal performance, where bc and bk are the loop extents of two register loops. The optimal set of loop extents can yield an optical performance of the processor 260, e.g., by enabling full utilization (or near-full utilization) of the registers. In some embodiments, the extent module 530 may maintain a heatmap stored in the heatmap datastore 540. The heatmap represents a relationship between various loop extent sets and the corresponding performances. The extent module 530 may identify an optimal set for the register loops from the heatmap.

In other embodiments, the extent module 530 may determine one or more sets of loop extents (“loop extent sets”) for a memory loop nest based on predicted misses of the corresponding memory. Each loop extent set includes loop extents for all the memory loops in the memory loop nest and corresponds to a different loop permutation determined by the permutation module 520. The loop extent set can minimize the misses of the memory if the memory loop nest is reordered based on the loop permutation. Taking a cache loop nest for example, the extent module 530 may determines one or more optimal loop extent sets for each loop permutation that the permutation module 520 has determined for the cache loop nest.

To determine optimal loop extent sets for a loop permutation of a memory loop nest, the extent module 530 may obtain a plurality of candidate loop extent sets. The candidate loop extent sets may be generated based on the original loop extents of the memory loops. The extent module 530 then uses the miss model 550 to determine whether a candidate loop extent set is an optimal loop extent set. For instance, the extent module 530 input the loop extents in the candidate loop extent set into the miss model 550. The extent module 530 may also input other attributes associated with the memory loop nest into the miss model 550. The attributes may include, for example, loop extents of inner loops, tensor references, data reuse factor, tensor operation, and so on. A data reuse factor indicates the extent to which data can be reused in a loop and can be determined through a data reuse analysis. The miss model 550 outputs a miss score that indicates a number of predicted misses of the memory. The extent module 530 can rank the candidate loop extent sets based on their miss scores and select one or more candidate loop extent sets as the optimal loop extent set(s) based on the ranking. For instance, the extent module 530 may select candidate loop extent sets having miss scores below a threshold score or lower than miss scores of the other candidate loop extent sets.

After the permutation module 520 determines the loop permutations and the extent module 530 determines the loop extents, the schedule tree generator 560 generates a schedule tree for the target IR. The schedule tree starts with a root that includes the target IR. The root is the first level of the schedule tree. The root has a couple of children as nodes in the second level of the target IR. Every node in the second level can be one permutation of the tiled loops with one loop extent set. A node may have one or more children spawned as new nodes. The schedule tree generator 560 may remove unit loops, i.e., loops whose extents equal 1. Additionally or alternatively, the schedule tree generator 560 may collapse adjacent parallel loops into a single parallel loop. Parallel loops are loops that can be executed in parallel, as opposed to being executed sequentially.

The training module 570 trains the miss model 550. The training module 570 applies machine learning techniques to generate the miss model 550 that when applied to attributes of a memory loop nest outputs a miss score indicating predicted memory misses. As part of the generation of the miss model 550, the training module 570 may form a training set. A training set includes training samples and ground-truth labels of the training samples. A training sample may include a set of attributes of a memory loop nest. The training sample may have a ground-truth miss score, the miss score may be a known miss score or a miss score that has been verified. The training module 570 extracts feature values from the training set, the features being variables deemed potentially relevant to memory misses. An ordered list of the features may be a feature vector. In one embodiment, the training module 570 applies dimensionality reduction (e.g., via LDA, PCA, or the like) to reduce the amount of data in the feature vectors to a smaller, more representative set of data.

The training module 570 may use supervised machine learning to train the miss model 550, e.g., with the feature vectors of the positive training set and the negative training set serving as the inputs. Different machine learning techniques—such as linear support vector machine (linear SVM), boosting for other algorithms (e.g., AdaBoost), neutral networks, logistic regression, naïve Bayes, memory-based learning, random forests, bagged trees, decision trees, boosted trees, or boosted stumps—may be used in different embodiments.

In some embodiments, a validation set is formed of data associated with additional memory loop nests, other than those in the training sets, which have known or verified miss scores. The training module 570 applies the trained miss model 550 to the memory loop nests of the validation set to quantify the accuracy of the miss model 550. The accuracy may be determined based on differences between miss scores determined by the miss model 550 and the known or verified miss scores. In one embodiment, the training module 570 iteratively re-trains the miss model 550 until the occurrence of a stopping condition, such as the accuracy measurement indication that the model is sufficiently accurate, or a number of training rounds having taken place.

In some embodiments, the training module 570 continuously trains a part of or the whole miss model 550. For instance, after the training module 570 trains the miss model 550, the miss model 550 receives attributes of a memory loop nest and outputs a miss score. The training module 570 may receive performance information after the processor 260 executes the tensor computation based on the memory loop nest. The training module 570 can determine a runtime miss score based on the performance information. The runtime miss score indicates the real memory misses during the execution of the tensor computation. The training module 570 uses the memory loop nest and the run time miss score as a new training sample to further train the miss model 550. The training module 570 can continuously generate new training sets and re-train the miss model 550 as it receives more performance information and determines more runtime miss scores.

### Example Schedule Tree

FIG. 6 illustrates an example schedule tree 600, in accordance with various embodiments. The schedule tree 600 may be generated by the schedule generator 430 in FIGS. 4 and 5. As shown in FIG. 6, the schedule tree 600 includes an IR 610 and four schedules 620, 625, 630, and 635. The IR 610 is the root of the schedule tree 600. The four schedules 620, 625, 630, and 635 are the nodes of the schedule tree 600, in which the schedules 620 and 625 are children of the root, versus the schedules 630 and 635 are grandchildren of the root. The schedules 620 and 630 constitute a first branch of the schedule tree 600. The schedules 625 and 635 constitute a second branch of the schedule tree 600. The IR 610 is the first level of the schedule tree 600. The schedules 620 and 625 are the second level. The schedules 630 and 635 are the third level.

The schedule 620 specifies a permutation of loops i and j, i.e., a change in the order of the loops i and j. The schedule 630, which is the child of the schedule 620, specifies tiling loop i by a tiling factor of g. For instance, the schedule 630 can split loop i into 2 loops: an outer loop and an inner loop. The extent of the outer loop may equal the original extent of loop i divided by g, and the extent of the inner loop may equal g. Alternatively, the extent of the inner loop may equal the original extent of loop i divided by g, and the extent of the outer loop may equal g. The schedule 630, as the child of the schedule 620, incorporates the schedule 620. In embodiments where the schedule 630 is selected for implementation, the loops i and j will be first permuted in accordance with the information in the schedule 620, then loop i will be split in accordance with the information in the schedule 630.

The schedule 625, which is in parallel with the schedule 620 and is a sibling of the schedule 625, specifies a permutation of loops m and n, i.e., a change in the order of the loops m and n. The schedule 635, which is the child of the schedule 625, specifies tiling loop m by a tiling factor h. For instance, the schedule 635 can split loop m into 2 loops: an outer loop and an inner loop. The extent of the outer loop may equal the original extent of loop m divided by h, and the extent of the inner loop may equal h. Alternatively, the extent of the inner loop may equal the original extent of loop m divided by h, and the extent of the outer loop may equal h. The schedule 635, as the child of the schedule 625, incorporates the schedule 625. In embodiments where the schedule 635 is selected for implementation, the loops m and n will be first permuted in accordance with the information in the schedule 625, then loop m will be split in accordance with the information in the schedule 635.

For purpose of simplicity and illustration, the schedule tree 600 in FIG. 6 includes four schedules, two branches, and three levels. In other embodiments, the schedule tree 600 may include a different number of schedules, a different number of branches, a different number of levels, a different structure, or some combination thereof.

### Example Method of Loop Transformation for Deep Learning

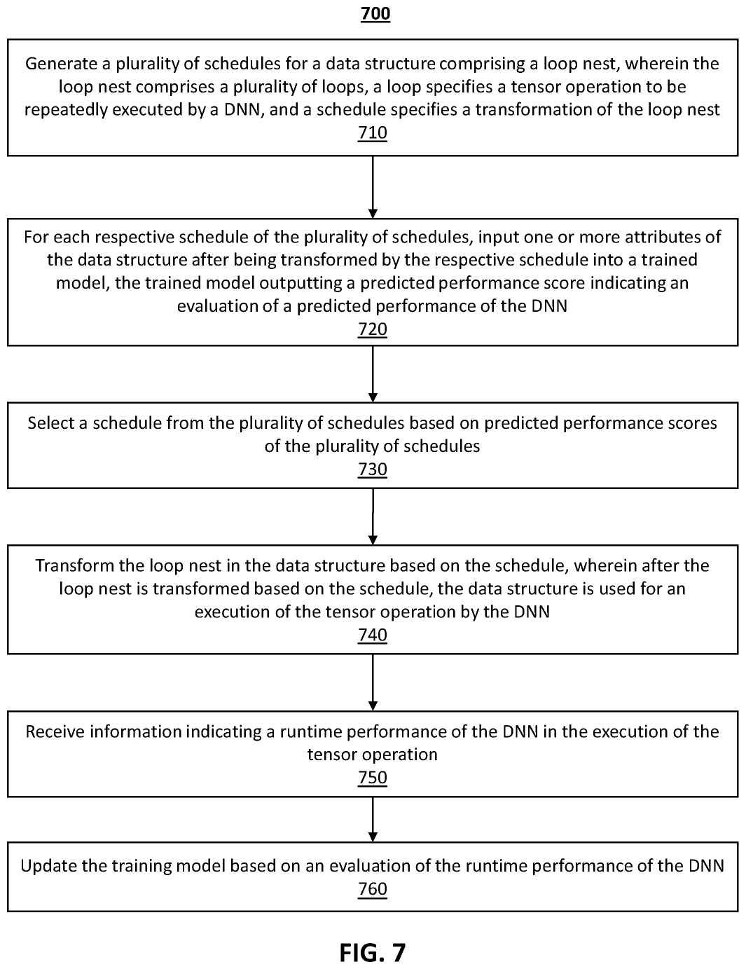

FIG. 7 is a flowchart showing a method 700 of loop transformation for deep learning, in accordance with various embodiments. The method 700 may be performed by the tensor compiler 230 in FIG. 2. Although the method 700 is described with reference to the flowchart illustrated in FIG. 7, many other methods for loop transformation for deep learning may alternatively be used. For example, the order of execution of the steps in FIG. 7 may be changed. As another example, some of the steps may be changed, eliminated, or combined.

The tensor compiler 230 generates 710 a plurality of schedules for a data structure. The data structure may be an IR, such as the IR 225. The data structure includes a loop nest. The loop nest comprises a plurality of loops. A loop specifies a tensor operation to be repeatedly executed by a DNN. The tensor operation may be convolution, pooling operation, elementwise operation, reducing, loading, or other types of tensor operation. A loop may be nested inside one or more other loops. A schedule specifies a transformation of the loop nest. The transformation may be loop permutation, index rewriting, loop unrolling, loop splitting, loop tiling, loop padding, other types of loop transformation, or some combination thereof. In some embodiments, the plurality of schedules may be arranged in a schedule tree, where the data structure is the root and the schedules are nodes. The schedule tree may include two or more levels. The root is in the first level. One or more schedules may be children of the root and located in the second level of the schedule tree. One or more other schedules may be children of a node in the second level and located in the third level of the schedule tree. For a level that includes multiple schedules, the schedules are siblings and may be in parallel.

For each respective schedule of the plurality of schedules, the tensor compiler 230 inputs 720 one or more attributes of the data structure after being transformed by the respective schedule into a trained model. The one or more attributes of the data structure after being transformed by the respective schedule are selected from a group consisting of a type of the tensor operation, a loop nest extent indicating a number of times the tensor operation to be repeatedly executed by the DNN, a tensor rank associated with the tensor operation, a tensor shape associated with the tensor operation, and a tensor length associated with the tensor operation.

The trained model outputs a predicted performance score indicating an evaluation of a predicted performance of the DNN. The predicted performance of the DNN may be a predicted performance of the DNN if the DNN executes the tensor operation based on the data structure after the loop nest is transformed using the respective schedule. An example of the trained model is the performance predictor 450 in FIG. 4. The DNN may be implemented in one or more processors, such as the processor 260. The DNN may include memories at different levels, such as registers, cache memories of various levels, and so on. An example of the DNN is the DNN 100 in FIG. 1.

The tensor compiler 230 selects 730 a schedule from the plurality of schedules based on predicted performance scores of the plurality of schedules. For instance, the tensor compiler 230 selects the schedule that has the highest predicted performance score, i.e., the schedule that can trigger the best performance of the DNN as predicted by the trained model.

The tensor compiler 230 transforms 740 the loop nest in the data structure based on the schedule. After the loop nest is transformed based on the schedule, the data structure is used for an execution of the tensor operation by the DNN. The tensor compiler 230 may generate an implementation from the transformation of the loop nest. The tensor compiler 230 may also instrument the implementation so that the DNN may generate performance information indicating a performance of the DNN in the execution of the tensor operation and transmit the performance information to the tensor compiler 230.

The tensor compiler 230 receives 750 information indicating a runtime performance of the DNN in the execution of the tensor operation. The tensor compiler 230 can evaluate the runtime performance of the DNN based on the information. The tensor compiler 230 can also compare the runtime performance with the predicted performance. In some embodiments, the tensor compiler 230 determines a runtime performance score for the schedule based on the information and compares the runtime performance score with the predicted performance score determined by the trained model. The tensor compiler 230 may determine a difference between the runtime performance score and the predicted performance score. The different can indicate an accuracy of the trained model in prediction of performance of the DNN.

The tensor compiler 230 updates 760 the training model based on an evaluation of the runtime performance of the DNN. In some embodiments, the tensor compiler 230 determines whether the difference between the runtime performance score and the predicted performance score is beyond a threshold. In response to determining that the difference is beyond a threshold, the tensor compiler 230 can form a training sample that includes the schedule and the runtime performance score and further train the trained model with the training sample. The runtime performance score can be used as a ground-truth label of the schedule in the process of further training the trained model. In some embodiments, the tensor compiler 230 may select a different schedule from the plurality of schedules by using the trained model that has been updated. The tensor compiler 230 may also transform the loop nest in the data structure based on the different schedule. After the loop nest is transformed based on the different schedule, the data structure is used for a new execution of the tensor operation by the DNN.

### Example Methods of Generating Schedule Tree

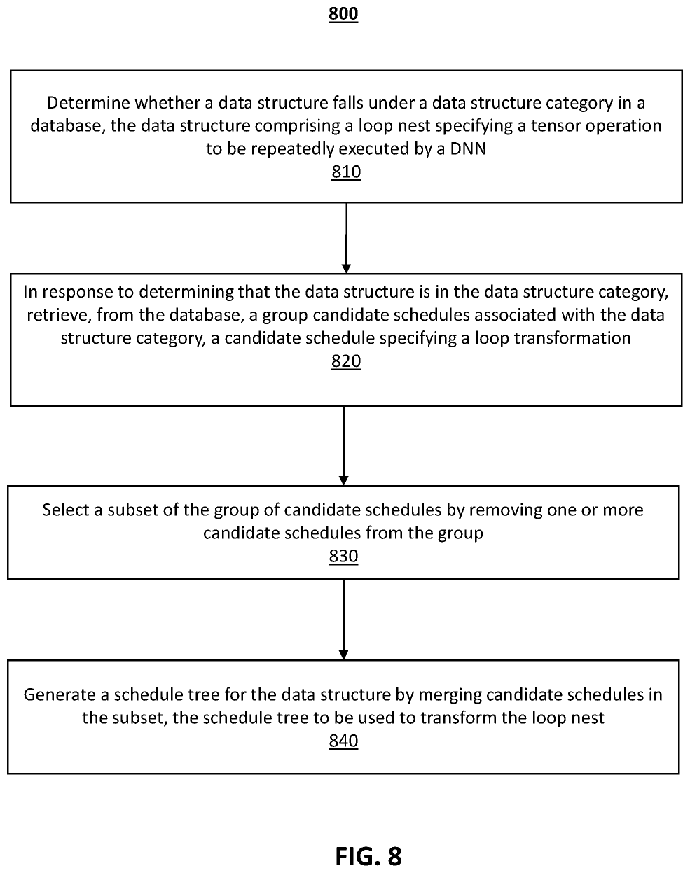

FIG. 8 is a flowchart showing a method 800 of generating a schedule tree for an IR, in accordance with various embodiments. The method 800 may be performed by the search module 410 in FIG. 4. Although the method 800 is described with reference to the flowchart illustrated in FIG. 8, many other methods for generating a schedule tree may alternatively be used. For example, the order of execution of the steps in FIG. 8 may be changed. As another example, some of the steps may be changed, eliminated, or combined.

The search module 410 determines 810 whether a data structure falls under a data structure category in a database. The data structure comprises a loop nest specifying a tensor operation to be repeatedly executed by a DNN. The tensor operation may be convolution, pooling operation, elementwise operation, reducing, loading, or other types of tensor operation. The loop nest comprises a plurality of loops. A loop may be nested inside one or more other loops. A schedule specifies a transformation of the loop nest. The DNN may be implemented in one or more processors, such as the processor 260. The DNN may include memories at different levels, such as registers, cache memories of various levels, and so on. An example of the DNN is the DNN 100 in FIG. 1.

In response to determining that the data structure is in the data structure category, the search module 410 retrieves 820, from the database, a group candidate schedules associated with the data structure category. A candidate schedule specifies a loop transformation. The loop transformation may be loop permutation, index rewriting, loop unrolling, loop splitting, loop tiling, loop padding, other types of loop transformation, or some combination thereof. The data structure category is a category of data structures that include the same tensor operation and tensor references but may have different loop extents.

The search module 410 selects 830 a subset of the group of candidate schedules by removing one or more candidate schedules from the group. In some embodiments, the group of candidate schedules includes a first candidate schedule and a second candidate schedule. The search module 410 may determine a similarity score indicating a similarity between the data structure and a data structure associated with the first candidate schedule. The search module 410 determines whether the similarity score is lower than a threshold score. After determining that the similarity score is lower than the threshold score, the search module 410 removes the first candidate schedule from the group. The search module 410 may also determine a similarity score indicating a similarity between the data structure and a data structure associated with the second candidate schedule. The search module 410 determines whether the similarity score of the second candidate schedule is lower than the threshold score. After determining that the similarity score is not lower than the threshold score, the search module 410 determines not to the second candidate schedule from the group. The search module 410 includes the second candidate schedule in the subset.

The search module 410 generates 840 a schedule tree for the data structure by merging candidate schedules in the subset. The candidate schedules in the subset may be arranged in the schedule tree based on their hierarchies. In some embodiments, the data structure is the root of the schedule tree, and the candidate schedules are nodes of the schedule tree. The schedule tree may include two or more levels. The root is in the first level. One or more schedules may be children of the root and located in the second level of the schedule tree. One or more other schedules may be children of a node in the second level and located in the third level of the schedule tree. For a level that includes multiple schedules, the schedules are siblings and may be in parallel.

The search module 410 may also remove one or more schedules in the schedule tree. For instance, the search module 410 may identify a schedule that specifies a loop tiling for splitting a loop in the loop nest into multiple new loops. The search module 410 may determining that the loop tiling is incompatible with the loop, e.g., based on a determination that the result of dividing the loop extent of the loop by the tiling factor (i.e., the number of new loops split from the loop in the loop nest) is not an integer. Then the search module 410 may remove the schedule for loop tiling from the schedule tree. Alternatively, the search module 410 may modify the loop that is incompatible with the schedule. For instance, the search module 410 adjust the loop extent to make the loop tiling compatible with the loop, e.g., to make the result of dividing the loop extent by the tiling factor an integer. In some embodiments such as embodiments where the loop tiling schedule is incompatible with multiple loops, the search module 410 may modify multiple loops in the loop nest. The search module 410 may start with the innermost loop, e.g., the register loop. After the innermost loop is modified, the search module 410 modifies the loop for the next memory level, e.g., the L0 cache loop. The search module 410 may continue this modifying process till the last incompatible loop is modified.

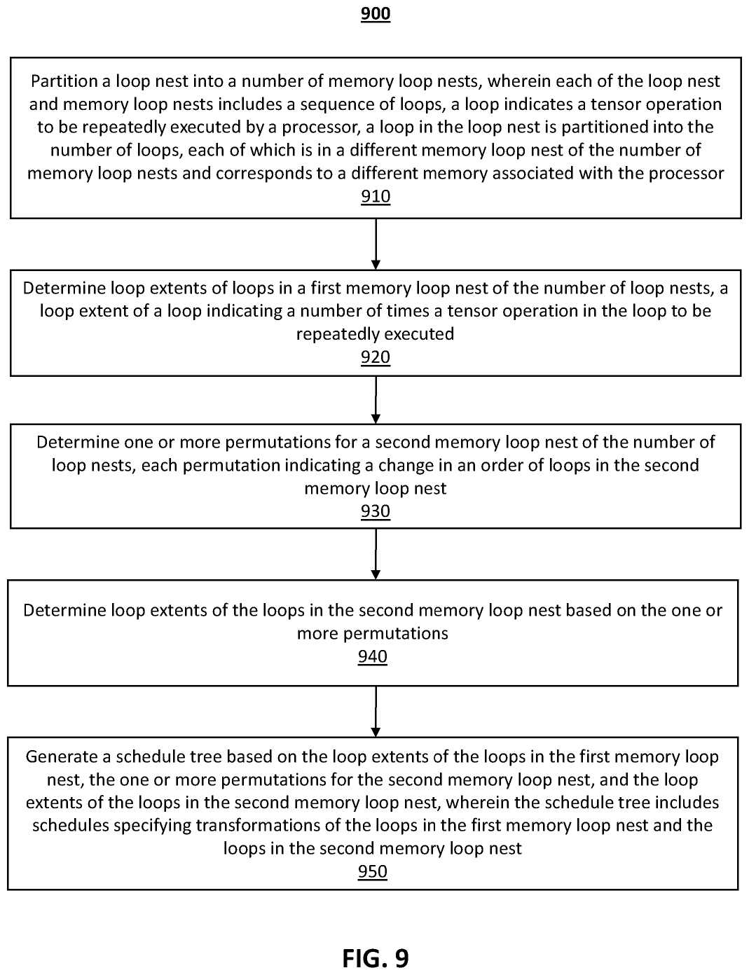

FIG. 9 is a flowchart showing another method 900 of generating a schedule tree for an IR, in accordance with various embodiments. The method 900 may be performed by the schedule generator 430 in FIG. 4. Although the method 900 is described with reference to the flowchart illustrated in FIG. 9, many other methods for generating a schedule tree may alternatively be used. For example, the order of execution of the steps in FIG. 9 may be changed. As another example, some of the steps may be changed, eliminated, or combined.

The schedule generator 430 partitions 910 a loop nest into a number of memory loop nests. Each of the loop nest and memory loop nests includes a sequence of loops. A loop indicates a tensor operation to be repeatedly executed by a processor. A loop in the loop nest is partitioned into the number of loops. Each of which is in a different memory loop nest of the number of memory loop nests and corresponds to a different memory associated with the processor. The partitioning can be done through loop tiling, and the tiling factor equals the number of memory levels associated with the processor.

The schedule generator 430 determines 920 loop extents of loops in a first memory loop nest of the number of loop nests. A loop extent of a loop indicates a number of times a tensor operation in the loop to be repeatedly executed. In some embodiments, the first memory loop nest may be the memory loop nest for registers. In other embodiments, the first memory loop nest may be the memory loop nest for a cache. The schedule generator 430 may determine one or more loop permutations for the first memory loop nest before the schedule generator 430 determines the loop extents.

The schedule generator 430 determines 930 one or more permutations for a second memory loop nest of the number of loop nests. The second memory loop nest is for a different memory level from the first memory loop nest. Each permutation indicating a change in an order of loops in the second memory loop nest. The second memory loop nest may be the memory loop nest for a cache.

The schedule generator 430 determine 940 loop extents of the loops in the second memory loop nest based on the one or more permutations. In some embodiments, the schedule generator 430 may determine a plurality of candidate sets. Each candidate set includes candidate loop extents for the loops in the second memory loop nest. For each respective candidate set, the inputs the candidate loop extents in the candidate set and the one or more attributes of the data structure into an additional trained model. The additional trained model outputs a miss score indicating predicted misses of a memory corresponding to the second memory loop nest if the DNN executes the tensor operation based on the data structure in which the loop nest is transformed based on the respective candidate set. An example of the additional trained model is the miss model 550 in FIG. 5. The schedule generator 430 then selects a candidate set from the plurality of candidate sets based on miss scores of the plurality of candidate sets. The candidate set includes the loop extents of the loops in the second memory loop nest. The schedule generator 430 may select the candidate set that has the lowest miss score that indicates the least memory misses.

The schedule generator 430 generate 950 a schedule tree based on the loop extents of the loops in the first memory loop nest, the one or more permutations for the second memory loop nest, and the loop extents of the loops in the second memory loop nest. The schedule tree includes schedules specifying transformations of the loops in the first memory loop nest and the loops in the second memory loop nest. In some embodiments, the schedule generator 430 may receive runtime performance information after the processor executes the tensor operation in accordance with the data structure transformed based on the schedule tree. The schedule generator 430 can use the runtime performance information to determine a runtime miss score that indicates an evaluation of memory misses that occurred during the execution of the tensor operation. The schedule generator 430 may use the selected candidate set and the runtime miss score as a training sample to further trin the additional trained model, e.g., after determining that a difference between the runtime miss score and the miss score determined by the additional trained model is beyond a threshold.

### Example Deep Learning Environment

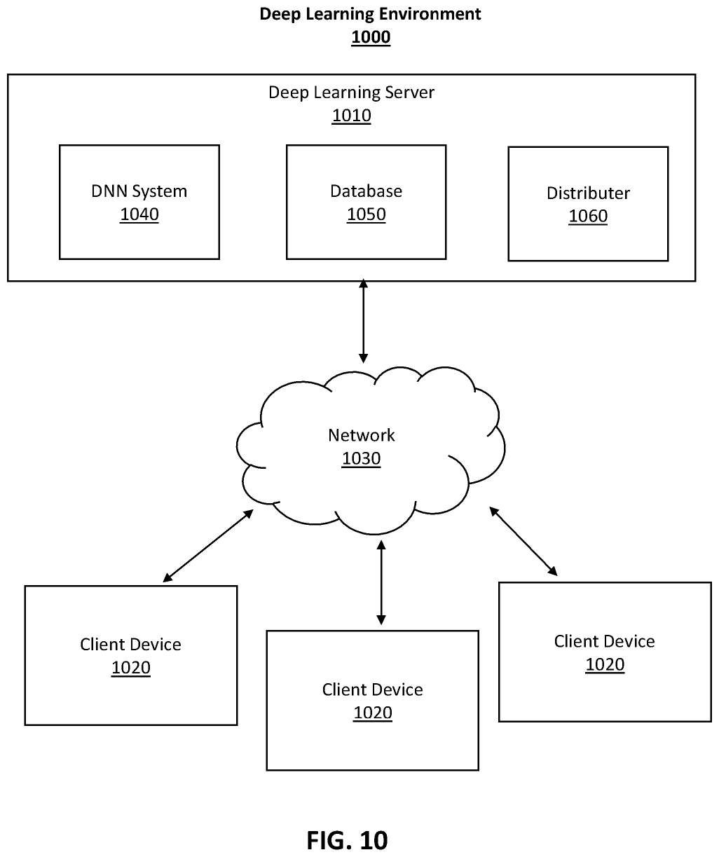

FIG. 10 illustrates a deep learning environment 1000, in accordance with various embodiments. The deep learning environment 1000 includes a deep learning server 1010 and a plurality of client devices 1020 (individually referred to as client device 1020). The deep learning server 1010 is connected to the client devices 1020 through a network 1030. In other embodiments, the deep learning environment 1000 may include fewer, more, or different components.

The deep learning server 1010 trains DL models using neural networks. A neural network is structured like the human brain and consists of artificial neurons, also known as nodes. These nodes are stacked next to each other in three types of layers: input layer, hidden layer(s), and output layer. Data provides each node with information in the form of inputs. The node multiplies the inputs with random weights, calculates them, and adds a bias. Finally, nonlinear functions, also known as activation functions, are applied to determine which neuron to fire. The deep learning server 1010 can use various types of neural networks, such as DNN, recurrent neural network (RNN), generative adversarial network (GAN), long short-term memory network (LSTMN), and so on. During the process of training the DL models, the neural networks use unknown elements in the input distribution to extract features, group objects, and discover useful data patterns. The DL models can be used to solve various problems, e.g., making predictions, classifying images, and so on. The deep learning server 1010 may build DL models specific to particular types of problems that need to be solved. A DL model is trained to receive an input and outputs the solution to the particular problem.

In FIG. 10, the deep learning server 1010 includes a DNN system 1040, a database 1050, and a distributer 1060. The DNN system 1040 trains DNNs. The DNNs can be used to process images, e.g., images captured by autonomous vehicles, medical devices, satellites, and so on. In an embodiment, a DNN receives an input image and outputs classifications of objects in the input image. An example of the DNNs is the DNN 100 described above in conjunction with FIG. 1. In some embodiments, the DNN system 1040 trains DNNs through knowledge distillation, e.g., dense-connection based knowledge distillation. The trained DNNs may be used on low memory systems, like mobile phones, IOT edge devices, and so on. An embodiment of the DNN system 1040 is the DNN system 200 described above in conjunction with FIG. 2.

The database 1050 stores data received, used, generated, or otherwise associated with the deep learning server 1010. For example, the database 1050 stores a training dataset that the DNN system 1040 uses to train DNNs. In an embodiment, the training dataset is an image gallery that can be used to train a DNN for classifying images. The training dataset may include data received from the client devices 1020. As another example, the database 1050 stores hyperparameters of the neural networks built by the deep learning server 1010.

The distributer 1060 distributes DL models generated by the deep learning server 1010 to the client devices 1020. In some embodiments, the distributer 1060 receives a request for a DNN from a client device 1020 through the network 1030. The request may include a description of a problem that the client device 1020 needs to solve. The request may also include information of the client device 1020, such as information describing available computing resource on the client device. The information describing available computing resource on the client device 1020 can be information indicating network bandwidth, information indicating available memory size, information indicating processing power of the client device 1020, and so on. In an embodiment, the distributer may instruct the DNN system 1040 to generate a DNN in accordance with the request. The DNN system 1040 may generate a DNN based on the information in the request. For instance, the DNN system 1040 can determine the structure of the DNN and/or train the DNN in accordance with the request.

In another embodiment, the distributer 1060 may select the DNN from a group of pre-existing DNNs based on the request. The distributer 1060 may select a DNN for a particular client device 1030 based on the size of the DNN and available resources of the client device 1020. In embodiments where the distributer 1060 determines that the client device 1020 has limited memory or processing power, the distributer 1060 may select a compressed DNN for the client device 1020, as opposed to an uncompressed DNN that has a larger size. The distributer 1060 then transmits the DNN generated or selected for the client device 1020 to the client device 1020.

In some embodiments, the distributer 1060 may receive feedback from the client device 1020. For example, the distributer 1060 receives new training data from the client device 1020 and may send the new training data to the DNN system 1040 for further training the DNN. As another example, the feedback includes an update of the available computer resource on the client device 1020. The distributer 1060 may send a different DNN to the client device 1020 based on the update. For instance, after receiving the feedback indicating that the computing resources of the client device 1020 have been reduced, the distributer 1060 sends a DNN of a smaller size to the client device 1020.

The client devices 1020 receive DNNs from the distributer 1060 and applies the DNNs to perform machine learning tasks, e.g., to solve problems or answer questions. In various embodiments, the client devices 1020 input images into the DNNs and uses the output of the DNNs for various applications, e.g., visual reconstruction, augmented reality, robot localization and navigation, medical diagnosis, weather prediction, and so on. A client device 1020 may be one or more computing devices capable of receiving user input as well as transmitting and/or receiving data via the network 1030. In one embodiment, a client device 1020 is a conventional computer system, such as a desktop or a laptop computer. Alternatively, a client device 1020 may be a device having computer functionality, such as a personal digital assistant (PDA), a mobile telephone, a smartphone, an autonomous vehicle, or another suitable device. A client device 1020 is configured to communicate via the network 1030. In one embodiment, a client device 1020 executes an application allowing a user of the client device 1020 to interact with the deep learning server 1010 (e.g., the distributer 1060 of the deep learning server 1010). The client device 1020 may request DNNs or send feedback to the distributer 1060 through the application. For example, a client device 1020 executes a browser application to enable interaction between the client device 1020 and the deep learning server 1010 via the network 1030. In another embodiment, a client device 1020 interacts with the deep learning server 1010 through an application programming interface (API) running on a native operating system of the client device 1020, such as IOS® or ANDROID™.

In an embodiment, a client device 1020 is an integrated computing device that operates as a standalone network-enabled device. For example, the client device 1020 includes display, speakers, microphone, camera, and input device. In another embodiment, a client device 1020 is a computing device for coupling to an external media device such as a television or other external display and/or audio output system. In this embodiment, the client device 1020 may couple to the external media device via a wireless interface or wired interface (e.g., an HDMI (High-Definition Multimedia Interface) cable) and may utilize various functions of the external media device such as its display, speakers, microphone, camera, and input devices. Here, the client device 1020 may be configured to be compatible with a generic external media device that does not have specialized software, firmware, or hardware specifically for interacting with the client device 1020.

The network 1030 supports communications between the deep learning server 1010 and client devices 1020. The network 1030 may comprise any combination of local area and/or wide area networks, using both wired and/or wireless communication systems. In one embodiment, the network 1030 may use standard communications technologies and/or protocols. For example, the network 1030 may include communication links using technologies such as Ethernet, 10010.11, worldwide interoperability for microwave access (WiMAX), 3G, 4G, code division multiple access (CDMA), digital subscriber line (DSL), etc. Examples of networking protocols used for communicating via the network 1030 may include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 1030 may be represented using any suitable format, such as hypertext markup language (HTML) or extensible markup language (XML). In some embodiments, all or some of the communication links of the network 1030 may be encrypted using any suitable technique or techniques.

### Example DNN System

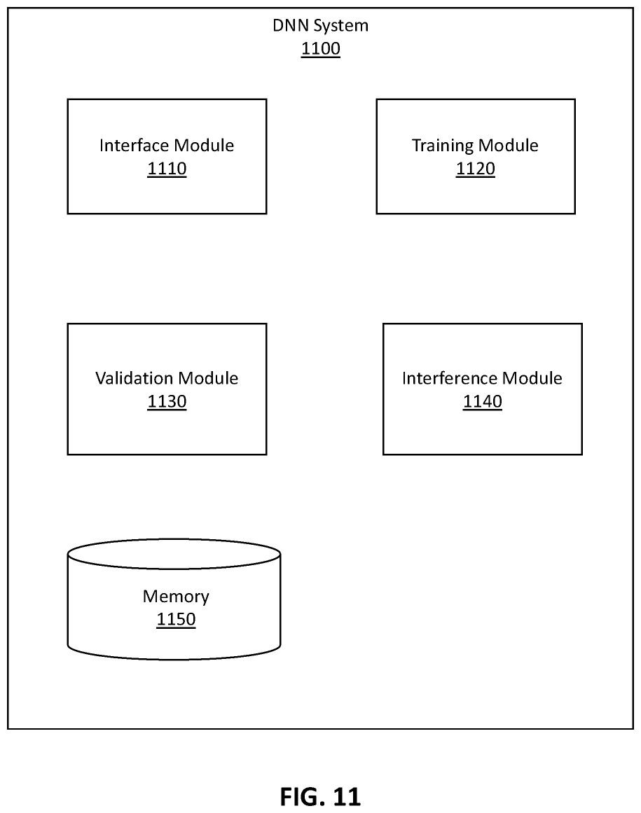

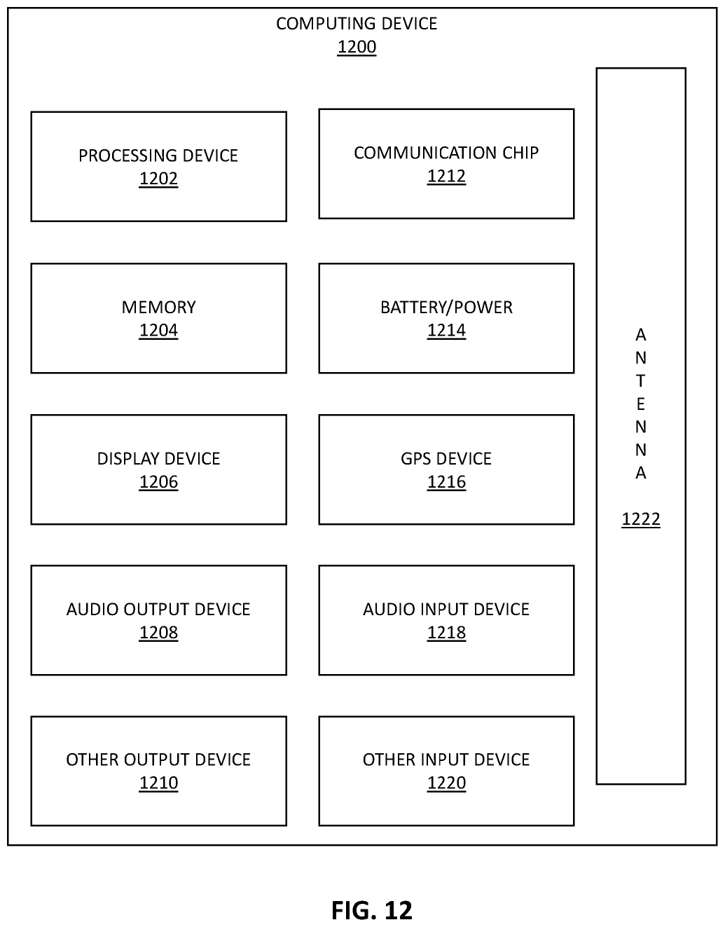

FIG. 11 is a block diagram of an example DNN system 1100, in accordance with various embodiments. The whole DNN system 1100 or a part of the DNN system 1100 may be implemented in the computing device 1200. The DNN system 1100 trains DNNs for various tasks, such as image classification, learning relationships between biological cells (e.g., DNA, proteins, etc.), control behaviors for devices (e.g., robots, machines, etc.), and so on. The DNN system 1100 includes an interface module 1110, a training module 1120, a validation module 1130, an inference module 1140, and a memory 1150. In other embodiments, alternative configurations, different or additional components may be included in the DNN system 1100. Further, functionality attributed to a component of the DNN system 1100 may be accomplished by a different component included in the DNN system 1100 or a different system. The DNN system 1100 or a component of the DNN system 1100 (e.g., the training module 1120 or inference module 1140) may include the computing device 1200 in FIG. 12.

The interface module 1110 facilitates communications of the DNN system 1100 with other systems. For example, the interface module 1110 establishes communications between the DNN system 1100 with an external database to receive data that can be used to train DNNs or input into DNNs to perform tasks. As another example, the interface module 1110 supports the DNN system 1100 to distribute DNNs to other systems, e.g., computing devices configured to apply DNNs to perform tasks.

The training module 1120 trains DNNs by using a training dataset. The training module 1120 forms the training dataset. In an embodiment where the training module 1120 trains an DNN to recognize objects in images, the training dataset includes training images and training labels. The training labels describe ground-truth classifications of objects in the training images. In some embodiments, each label in the training dataset corresponds to an object in a training image. In some embodiments, a part of the training dataset may be used to initially train the DNN, and the rest of the training dataset may be held back as a validation subset used by the validation module 1130 to validate performance of a trained DNN. The portion of the training dataset not including the tuning subset and the validation subset may be used to train the DNN.

The training module 1120 also determines hyperparameters for training the DNN. Hyperparameters are variables specifying the DNN training process. Hyperparameters are different from parameters inside the DNN (e.g., weights of filters). In some embodiments, hyperparameters include variables determining the architecture of the DNN, such as number of hidden layers, etc. Hyperparameters also include variables which determine how the DNN is trained, such as batch size, number of epochs, etc. A batch size defines the number of training samples to work through before updating the parameters of the DNN. The batch size is the same as or smaller than the number of samples in the training dataset. The training dataset can be divided into one or more batches. The number of epochs defines how many times the entire training dataset is passed forward and backwards through the entire network. The number of epochs defines the number of times that the deep learning algorithm works through the entire training dataset. One epoch means that each training sample in the training dataset has had an opportunity to update the parameters inside the DNN. An epoch may include one or more batches. The number of epochs may be 11, 110, 500, 1100, or even larger.

The training module 1120 defines the architecture of the DNN, e.g., based on some of the hyperparameters. The architecture of the DNN includes an input layer, an output layer, and a plurality of hidden layers. The input layer of an DNN may include tensors (e.g., a multidimensional array) specifying attributes of the input image, such as the height of the input image, the width of the input image, and the depth of the input image (e.g., the number of bits specifying the color of a pixel in the input image). The output layer includes labels of objects in the input layer. The hidden layers are layers between the input layer and output layer. The hidden layers include one or more convolutional layers and one or more other types of layers, such as pooling layers, fully connected layers, normalization layers, softmax or logistic layers, and so on. The convolutional layers of the DNN abstract the input image to a feature map that is represented by a tensor specifying the feature map height, the feature map width, and the feature map channels (e.g., red, green, blue images include three channels). A pooling layer is used to reduce the spatial volume of input image after convolution. It is used between two convolution layers. A fully connected layer involves weights, biases, and neurons. It connects neurons in one layer to neurons in another layer. It is used to classify images between different category by training.

In the process of defining the architecture of the DNN, the training module 1120 also adds an activation function to a hidden layer or the output layer. An activation function of a layer transforms the weighted sum of the input of the layer to an output of the layer. The activation function may be, for example, a rectified linear unit activation function, a tangent activation function, or other types of activation functions.

After the training module 1120 defines the architecture of the DNN, the training module 1120 inputs a training dataset into the DNN. The training dataset includes a plurality of training samples. An example of a training sample includes an object in an image and a ground-truth label of the object. The training module 1120 modifies the parameters inside the DNN (“internal parameters of the DNN”) to minimize the error between labels of the training objects that are generated by the DNN and the ground-truth labels of the objects. The internal parameters include weights of filters in the convolutional layers of the DNN. In some embodiments, the training module 1120 uses a cost function to minimize the error.

The training module 1120 may train the DNN for a predetermined number of epochs. The number of epochs is a hyperparameter that defines the number of times that the DL algorithm will work through the entire training dataset. One epoch means that each sample in the training dataset has had an opportunity to update internal parameters of the DNN. After the training module 1120 finishes the predetermined number of epochs, the training module 1120 may stop updating the parameters in the DNN. The DNN having the updated parameters is referred to as a trained DNN.

The validation module 1130 verifies accuracy of trained DNNs. In some embodiments, the validation module 1130 inputs samples in a validation dataset into a trained DNN and uses the outputs of the DNN to determine the model accuracy. In some embodiments, a validation dataset may be formed of some or all the samples in the training dataset. Additionally or alternatively, the validation dataset includes additional samples, other than those in the training sets. In some embodiments, the validation module 1130 determines may determine an accuracy score measuring the precision, recall, or a combination of precision and recall of the DNN. The validation module 1130 may use the following metrics to determine the accuracy score: Precision=TP/(TP+FP) and Recall=TP/(TP+FN), where precision may be how many the reference classification model correctly predicted (TP or true positives) out of the total it predicted (TP+FP or false positives), and recall may be how many the reference classification model correctly predicted (TP) out of the total number of objects that did have the property in question (TP+FN or false negatives). The F-score (F-score=2*PR/(P+R)) unifies precision and recall into a single measure.

The validation module 1130 may compare the accuracy score with a threshold score. In an example where the validation module 1130 determines that the accuracy score of the augmented model is lower than the threshold score, the validation module 1130 instructs the training module 1120 to re-train the DNN. In one embodiment, the training module 1120 may iteratively re-train the DNN until the occurrence of a stopping condition, such as the accuracy measurement indication that the DNN may be sufficiently accurate, or a number of training rounds having taken place.

The inference module 1140 applies the trained or validated DNN to perform tasks. For instance, the inference module 1140 inputs images into the DNN. The DNN outputs classifications of objects in the images. As an example, the DNN may be provisioned in a security setting to detect malicious or hazardous objects in images captured by security cameras. As another example, the DNN may be provisioned to detect objects (e.g., road signs, hazards, humans, pets, etc.) in images captured by cameras of an autonomous vehicle. The input to the DNN may be formatted according to a predefined input structure mirroring the way that the training dataset was provided to the DNN. The DNN may generate an output structure which may be, for example, a classification of the image, a listing of detected objects, a boundary of detected objects, or the like. In some embodiments, the inference module 1140 distributes the DNN to other systems, e.g., computing devices in communication with the DNN system 1100, for the other systems to apply the DNN to perform the tasks.

The memory 1150 stores data received, generated, used, or otherwise associated with the DNN system 1100. For example, the memory 1150 stores the datasets used by the training module 1120 and validation module 1130. The memory 1150 may also store data generated by the training module 1120 and validation module 1130, such as the hyperparameters for training DNNs, internal parameters of trained DNNs (e.g., values of tunable parameters of FALUs), etc. In the embodiment of FIG. 11, the memory 1150 is a component of the DNN system 1100. In other embodiments, the memory 1150 may be external to the DNN system 1100 and communicate with the DNN system 1100 through a network.

### Example Computing Device

FIG. 12 is a block diagram of an example computing device 1200, in accordance with various embodiments. In some embodiments, the computing device 1200 can be used as the DNN system 1100 in FIG. 11. A number of components are illustrated in FIG. 12 as included in the computing device 1200, but any one or more of these components may be omitted or duplicated, as suitable for the application. In some embodiments, some or all of the components included in the computing device 1200 may be attached to one or more motherboards. In some embodiments, some or all of these components are fabricated onto a single system on a chip (SoC) die. Additionally, in various embodiments, the computing device 1200 may not include one or more of the components illustrated in FIG. 12, but the computing device 1200 may include interface circuitry for coupling to the one or more components. For example, the computing device 1200 may not include a display device 1206, but may include display device interface circuitry (e.g., a connector and driver circuitry) to which a display device 1206 may be coupled. In another set of examples, the computing device 1200 may not include an audio input device 1218 or an audio output device 1208, but may include audio input or output device interface circuitry (e.g., connectors and supporting circuitry) to which an audio input device 1218 or audio output device 1208 may be coupled.

The computing device 1200 may include a processing device 1202 (e.g., one or more processing devices). The processing device 1202 processes electronic data from registers and/or memory to transform that electronic data into other electronic data that may be stored in registers and/or memory. An embodiment of the processing device 1202 may be the processor 260 in FIG. 2. The computing device 1200 may include a memory 1204, which may itself include one or more memory devices such as volatile memory (e.g., DRAM), nonvolatile memory (e.g., read-only memory (ROM)), high bandwidth memory (HBM), flash memory, solid state memory, and/or a hard drive. In some embodiments, the memory 1204 may include memory that shares a die with the processing device 1202. In some embodiments, the memory 1204 includes one or more non-transitory computer-readable media storing instructions executable to perform operations for deep learning, e.g., the methods 700, 800, and 900 described above in conjunction with FIGS. 7-9 or the operations performed by the tensor compiler 230 described above in conjunction with FIGS. 2-5. The instructions stored in the one or more non-transitory computer-readable media may be executed by the processing device 2402.

In some embodiments, the computing device 1200 may include a communication chip 1212 (e.g., one or more communication chips). For example, the communication chip 1212 may be configured for managing wireless communications for the transfer of data to and from the computing device 1200. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not.

The communication chip 1212 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication chip 1212 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication chip 1212 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 1212 may operate in accordance with CDMA, Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 1212 may operate in accordance with other wireless protocols in other embodiments. The computing device 1200 may include an antenna 1222 to facilitate wireless communications and/or to receive other wireless communications (such as AM or FM radio transmissions).

In some embodiments, the communication chip 1212 may manage wired communications, such as electrical, optical, or any other suitable communication protocols (e.g., the Ethernet). As noted above, the communication chip 1212 may include multiple communication chips. For instance, a first communication chip 1212 may be dedicated to shorter-range wireless communications such as Wi-Fi or Bluetooth, and a second communication chip 1212 may be dedicated to longer-range wireless communications such as global positioning system (GPS), EDGE, GPRS, CDMA, WiMAX, LTE, EV-DO, or others. In some embodiments, a first communication chip 1212 may be dedicated to wireless communications, and a second communication chip 1212 may be dedicated to wired communications.

The computing device 1200 may include battery/power circuitry 1214. The battery/power circuitry 1214 may include one or more energy storage devices (e.g., batteries or capacitors) and/or circuitry for coupling components of the computing device 1200 to an energy source separate from the computing device 1200 (e.g., AC line power).

The computing device 1200 may include a display device 1206 (or corresponding interface circuitry, as discussed above). The display device 1206 may include any visual indicators, such as a heads-up display, a computer monitor, a projector, a touchscreen display, a liquid crystal display (LCD), a light-emitting diode display, or a flat panel display, for example.

The computing device 1200 may include an audio output device 1208 (or corresponding interface circuitry, as discussed above). The audio output device 1208 may include any device that generates an audible indicator, such as speakers, headsets, or earbuds, for example.

The computing device 1200 may include an audio input device 1218 (or corresponding interface circuitry, as discussed above). The audio input device 1218 may include any device that generates a signal representative of a sound, such as microphones, microphone arrays, or digital instruments (e.g., instruments having a musical instrument digital interface (MIDI) output).

The computing device 1200 may include a GPS device 1216 (or corresponding interface circuitry, as discussed above). The GPS device 1216 may be in communication with a satellite-based system and may receive a location of the computing device 1200, as known in the art.

The computing device 1200 may include an other output device 1210 (or corresponding interface circuitry, as discussed above). Examples of the other output device 1210 may include an audio codec, a video codec, a printer, a wired or wireless transmitter for providing information to other devices, or an additional storage device.

The computing device 1200 may include an other input device 1220 (or corresponding interface circuitry, as discussed above). Examples of the other input device 1220 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (register fileID) reader.

The computing device 1200 may have any desired form factor, such as a handheld or mobile computer system (e.g., a cell phone, a smart phone, a mobile internet device, a music player, a tablet computer, a laptop computer, a netbook computer, an ultrabook computer, a PDA, an ultramobile personal computer, etc.), a desktop computer system, a server or other networked computing component, a printer, a scanner, a monitor, a set-top box, an entertainment control unit, a vehicle control unit, a digital camera, a digital video recorder, or a wearable computer system. In some embodiments, the computing device 1200 may be any other electronic device that processes data.

### Select Examples

The following paragraphs provide various examples of the embodiments disclosed herein.
Example 1 provides a method for deep learning, the method including generating a plurality of schedules for a data structure including a loop nest, where the loop nest includes a plurality of loops, a loop specifies a tensor operation to be repeatedly executed by DNN, and a schedule specifies a transformation of the loop nest; for each respective schedule of the plurality of schedules, inputting one or more attributes of the data structure after being transformed by the respective schedule into a trained model, the trained model outputting a predicted performance score indicating an evaluation of a predicted performance of the DNN; selecting a schedule from the plurality of schedules based on predicted performance scores of the plurality of schedules; transforming the loop nest in the data structure based on the schedule, where after the loop nest is transformed based on the schedule, the data structure is used for an execution of the tensor operation by the DNN; receiving information indicating a runtime performance of the DNN in the execution of the tensor operation; and updating the training model based on an evaluation of the runtime performance of the DNN.
Example 2 provides the method of example 1, where updating the training model based on the evaluation of the runtime performance of the DNN includes determining a runtime performance score indicating the evaluation of the runtime performance of the DNN; forming a training sample that includes the runtime performance score and one or more parameters associated with the schedule; and further training the trained model by using the training sample.
Example 3 provides the method of example 1 or 2, further including selecting a different schedule from the plurality of schedules by using the trained model that has been updated; and transforming the loop nest in the data structure based on the different schedule, where after the loop nest is transformed based on the different schedule, the data structure is used for a new execution of the tensor operation by the DNN.
Example 4 provides the method of any of the preceding examples, where generating the plurality of schedules for the data structure includes determining whether a data structure is in a data structure category in a database; in response to determining that the data structure is in the data structure category, retrieving, from the database, candidate schedules associated with the data structure category; and generating the plurality of schedules from the candidate schedules.
Example 5 provides the method of example 4, where the candidate schedules include a first candidate schedule and a second candidate schedule, and generating the plurality of schedules for the data structure includes determining a similarity score indicating a similarity between the data structure and a data structure associated with the first candidate schedule; and after determining that the similarity score is lower than a threshold score, generating the plurality of schedules based on the second candidate schedule and not based on the first candidate schedule.
Example 6 provides the method of example 4 or 5, where the candidate schedules include a first candidate schedule and a second candidate schedule, the first candidate schedule specifies a loop tiling for splitting a loop in the loop nest into multiple loops, and generating the plurality of schedules for the data structure includes determining that the loop tiling is incompatible with a tensor associated with the loop; and generating the plurality of schedules based on the second candidate schedule and not based on the first candidate schedule.
Example 7 provides the method of any of the preceding examples, where generating the plurality of schedules for the data structure includes partitioning the loop nest into a number of memory loop nests, where each of the loop nest and memory loop nests includes a sequence of loops, a loop indicates a tensor operation to be repeatedly executed by a processor, a loop in the loop nest is partitioned into the number of loops, each of which is in a different memory loop nest of the number of memory loop nests and corresponds to a different memory associated with the processor; determining loop extents of loops in a memory loop nest of the number of loop nests, a loop extent of a loop indicating a number of times a tensor operation in the loop to be repeatedly executed; and generating the plurality of schedules based on the loop extents.
Example 8 provides the method of example 7, where the memory loop nest is a first memory loop nest, and generating the plurality of schedules for the data structure further includes determining one or more permutations for a second memory loop nest of the number of loop nests, each permutation indicating a change in an order of loops in the second memory loop nest; determine loop extents of the loops in the second memory loop nest based on the one or more permutations; and generating the plurality of schedules further based on the one or more permutations for the second memory loop nest and the loop extents of the loops in the second memory loop nest.
Example 9 provides the method of example 8, where determine the loop extents of the loops in the second memory loop nest includes determining a plurality of candidate sets, each candidate set including candidate loop extents for the loops in the second memory loop nest; for each respective candidate set, inputting the candidate loop extents in the candidate set and the one or more attributes of the data structure into an additional trained model, the additional trained model outputting a miss score indicating predicted misses of a memory corresponding to the second memory loop nest if the DNN executes the tensor operation based on the data structure in which the loop nest is transformed based on the respective candidate set; and selecting a candidate set from the plurality of candidate sets based on miss scores of the plurality of candidate sets, where the candidate set includes the loop extents of the loops in the second memory loop nest.
Example 10 provides the method of any of the preceding examples, where the one or more attributes of the data structure after being transformed by the respective schedule are selected from a group consisting of a type of the tensor operation, a loop nest extent indicating a number of times the tensor operation to be repeatedly executed by the DNN, a tensor rank associated with the tensor operation, a tensor shape associated with the tensor operation, and a tensor length associated with the tensor operation.
Example 11 provides one or more non-transitory computer-readable media storing instructions executable to perform operations for deep learning, the operations including generating a plurality of schedules for a data structure including a loop nest, where the loop nest includes a plurality of loops, a loop specifies a tensor operation to be repeatedly executed by DNN, and a schedule specifies a transformation of the loop nest; for each respective schedule of the plurality of schedules, inputting one or more attributes of the data structure after being transformed by the respective schedule into a trained model, the trained model outputting a predicted performance score indicating an evaluation of a predicted performance of the DNN; selecting a schedule from the plurality of schedules based on predicted performance scores of the plurality of schedules; transforming the loop nest in the data structure based on the schedule, where after the loop nest is transformed based on the schedule, the data structure is used for an execution of the tensor operation by the DNN; receiving information indicating a runtime performance of the DNN in the execution of the tensor operation; and updating the training model based on an evaluation of the runtime performance of the DNN.
Example 12 provides the one or more non-transitory computer-readable media of example 11, where updating the training model based on the evaluation of the runtime performance of the DNN includes determining a runtime performance score indicating the evaluation of the runtime performance of the DNN; forming a training sample that includes the runtime performance score and one or more parameters associated with the schedule; and further training the trained model by using the training sample.
Example 13 provides the one or more non-transitory computer-readable media of example 12, where operations further include selecting a different schedule from the plurality of schedules by using the trained model that has been updated; and transforming the loop nest in the data structure based on the different schedule, where after the loop nest is transformed based on the different schedule, the data structure is used for a new execution of the tensor operation by the DNN.
Example 14 provides the one or more non-transitory computer-readable media of any one of examples 11-13, where generating the plurality of schedules for the data structure includes determining whether a data structure is in a data structure category in a database; in response to determining that the data structure is in the data structure category, retrieving, from the database, candidate schedules associated with the data structure category; and generating the plurality of schedules from the candidate schedules.
Example 15 provides the one or more non-transitory computer-readable media of example 14, where the candidate schedules include a first candidate schedule and a second candidate schedule, and generating the plurality of schedules for the data structure includes determining a similarity score indicating a similarity between the data structure and a data structure associated with the first candidate schedule; and after determining that the similarity score is lower than a threshold score, generating the plurality of schedules based on the second candidate schedule and not based on the first candidate schedule.
Example 16 provides the one or more non-transitory computer-readable media of example 14 or 15, where the candidate schedules include a first candidate schedule and a second candidate schedule, the first candidate schedule specifies a loop tiling for splitting a loop in the loop nest into multiple loops, and generating the plurality of schedules for the data structure includes determining that the loop tiling is incompatible with a tensor associated with the loop; and generating the plurality of schedules based on the second candidate schedule and not based on the first candidate schedule.
Example 17 provides the one or more non-transitory computer-readable media of any one of examples 11-16, where generating the plurality of schedules for the data structure includes partitioning the loop nest into a number of memory loop nests, where each of the loop nest and memory loop nests includes a sequence of loops, a loop indicates a tensor operation to be repeatedly executed by a processor, a loop in the loop nest is partitioned into the number of loops, each of which is in a different memory loop nest of the number of memory loop nests and corresponds to a different memory associated with the processor; determining loop extents of loops in a memory loop nest of the number of loop nests, a loop extent of a loop indicating a number of times a tensor operation in the loop to be repeatedly executed; and generating the plurality of schedules based on the loop extents.
Example 18 provides the one or more non-transitory computer-readable media of example 17, where the memory loop nest is a first memory loop nest, and generating the plurality of schedules for the data structure further includes determining one or more permutations for a second memory loop nest of the number of loop nests, each permutation indicating a change in an order of loops in the second memory loop nest; determine loop extents of the loops in the second memory loop nest based on the one or more permutations; and generating the plurality of schedules further based on the one or more permutations for the second memory loop nest and the loop extents of the loops in the second memory loop nest.
Example 19 provides the one or more non-transitory computer-readable media of example 18, where determine the loop extents of the loops in the second memory loop nest includes determining a plurality of candidate sets, each candidate set including candidate loop extents for the loops in the second memory loop nest; for each respective candidate set, inputting the candidate loop extents in the candidate set and the one or more attributes of the data structure into an additional trained model, the additional trained model outputting a miss score indicating predicted misses of a memory corresponding to the second memory loop nest if the DNN executes the tensor operation based on the data structure in which the loop nest is transformed based on the respective candidate set; and selecting a candidate set from the plurality of candidate sets based on miss scores of the plurality of candidate sets, where the candidate set includes the loop extents of the loops in the second memory loop nest.
Example 20 provides the one or more non-transitory computer-readable media of any one of examples 11-19, where the one or more attributes of the data structure after being transformed by the respective schedule are selected from a group consisting of a type of the tensor operation, a loop nest extent indicating a number of times the tensor operation to be repeatedly executed by the DNN, a tensor rank associated with the tensor operation, a tensor shape associated with the tensor operation, and a tensor length associated with the tensor operation.
Example 21 provides an apparatus for deep learning, the apparatus including a computer processor for repeatedly executing a tensor operation in accordance with computer program instructions; and a tensor compiler configured to perform operations including generating a plurality of schedules for a data structure including a loop nest, where the data structure is generated based on the computer program instructions, the loop nest includes a plurality of loops, a loop specifies the tensor operation to be repeatedly executed by the processor, and a schedule specifies a transformation of the loop nest, for each respective schedule of the plurality of schedules, inputting one or more attributes of the data structure after being transformed by the respective schedule into a trained model, the trained model outputting a predicted performance score indicating an evaluation of a predicted performance of the processor, selecting a schedule from the plurality of schedules based on predicted performance scores of the plurality of schedules, transforming the loop nest in the data structure based on the schedule, where after the loop nest is transformed based on the schedule, the data structure is used for an execution of the tensor operation by the processor, receiving information indicating a runtime performance of the processor in the execution of the tensor operation, and updating the training model based on an evaluation of the runtime performance of the processor.
Example 22 provides the apparatus of example 21, where updating the training model based on the evaluation of the runtime performance of the processor includes determining a runtime performance score indicating the evaluation of the runtime performance of the processor; forming a training sample that includes the runtime performance score and one or more parameters associated with the schedule; and further training the trained model by using the training sample.
Example 23 provides the apparatus of example 21 or 22, where the operations further include selecting a different schedule from the plurality of schedules by using the trained model that has been updated; and transforming the loop nest in the data structure based on the different schedule, where after the loop nest is transformed based on the different schedule, the data structure is used for a new execution of the tensor operation by the processor.
Example 24 provides the apparatus of any one of examples 21-23, where generating the plurality of schedules for the data structure includes determining whether a data structure is in a data structure category in a database; in response to determining that the data structure is in the data structure category, retrieving, from the database, candidate schedules associated with the data structure category; and generating the plurality of schedules from the candidate schedules.
Example 25 provides the apparatus of any one of examples 21-24, where generating the plurality of schedules for the data structure includes partitioning the loop nest into a number of memory loop nests, where each of the loop nest and memory loop nests includes a sequence of loops, a loop indicates a tensor operation to be repeatedly executed by a processor, a loop in the loop nest is partitioned into the number of loops, each of which is in a different memory loop nest of the number of memory loop nests and corresponds to a different memory associated with the processor; determining loop extents of loops in a memory loop nest of the number of loop nests, a loop extent of a loop indicating a number of times a tensor operation in the loop to be repeatedly executed; and generating the plurality of schedules based on the loop extents.

### Select Examples

Example 1 provides a method for deep learning, the method including determining whether a data structure falls under a data structure category, where the data structure includes a loop nest, the loop nest includes a plurality of loops, and a loop specifies a tensor operation to be repeatedly executed by a DNN; in response to determining that the data structure is in the data structure category, retrieving a plurality of schedule trees associated with the data structure category, where each schedule tree includes one or more schedules, and a schedule specifies a loop transformation of the loop nest; and generating a new schedule tree for the data structure by merging at least some of the plurality of schedule trees, where the new schedule tree is to be used to transform the loop nest.
Example 2 provides the method of example 1, where determining whether the data structure falls under the data structure category includes determining whether the tensor operation matches a tensor operation in the data structure category.
Example 3 provides the method of example 2, where determining whether the data structure falls under the data structure category further includes determining whether one or more tensor references in the data structure match corresponding one or more tensor references in the data structure category, where a tensor reference is a tensor rank, tensor shape, or a tensor length.
Example 4 provides the method of any of the preceding examples, further including selecting a group of schedule trees from the plurality of schedule trees, where the group of schedule trees is a subset of the plurality of schedule trees, and generating the new schedule tree includes generating the new schedule tree by merging the group of schedule trees.
Example 5 provides the method of example 4, where selecting the group of schedule trees from the plurality of schedule trees includes removing one or more schedule trees from the plurality of schedule trees.
Example 6 provides the method of example 5, where removing the one or more schedule trees from the plurality of schedule trees includes for each respective schedule tree of the plurality of schedule trees, determining a similarity score indicating a similarity between the data structure and a corresponding data structure of the plurality of data structures; and removing the one or more schedule trees based on similarity scores of the one or more schedule trees.
Example 7 provides the method of any of the preceding examples, further including in response to determining that the data structure is not in the data structure category, generating a schedule tree for the data structure based on the loop nest.
Example 8 provides one or more non-transitory computer-readable media storing instructions executable to perform operations for deep learning, the operations including determining whether a data structure falls under a data structure category, where the data structure includes a loop nest, the loop nest includes a plurality of loops, and a loop specifies a tensor operation to be repeatedly executed by a DNN; in response to determining that the data structure is in the data structure category, retrieving a plurality of schedule trees associated with the data structure category, where each schedule tree includes one or more schedules, and a schedule specifies a loop transformation of the loop nest; and generating a new schedule tree for the data structure by merging at least some of the plurality of schedule trees, where the new schedule tree is to be used to transform the loop nest.
Example 9 provides the one or more non-transitory computer-readable media of example 8, where determining whether the data structure falls under the data structure category includes determining whether the tensor operation matches a tensor operation in the data structure category.
Example 10 provides the one or more non-transitory computer-readable media of example 9, where determining whether the data structure falls under the data structure category further includes determining whether one or more tensor references in the data structure match corresponding one or more tensor references in the data structure category, where a tensor reference is a tensor rank, tensor shape, or a tensor length.
Example 11 provides the one or more non-transitory computer-readable media of any one of examples 8-10, where the operations further include selecting a group of schedule trees from the plurality of schedule trees, where the group of schedule trees is a subset of the plurality of schedule trees, and generating the new schedule tree includes generating the new schedule tree by merging the group of schedule trees.
Example 12 provides the one or more non-transitory computer-readable media of example 11, where selecting the group of schedule trees from the plurality of schedule trees includes removing one or more schedule trees from the plurality of schedule trees.
Example 13 provides the one or more non-transitory computer-readable media of example 12, where removing the one or more schedule trees from the plurality of schedule trees includes for each respective schedule tree of the plurality of schedule trees, determining a similarity score indicating a similarity between the data structure and a corresponding data structure of the plurality of data structures; and removing the one or more schedule trees based on similarity scores of the one or more schedule trees.
Example 14 provides the one or more non-transitory computer-readable media of any one of examples 8-13, where the operations further include in response to determining that the data structure is not in the data structure category, generating a schedule tree for the data structure based on the loop nest.
Example 15 provides an apparatus for deep learning, the apparatus including a computer processor for executing computer program instructions; and a non-transitory computer-readable memory storing computer program instructions executable by the computer processor to perform operations including determining whether a data structure falls under a data structure category, where the data structure includes a loop nest, the loop nest includes a plurality of loops, and a loop specifies a tensor operation to be repeatedly executed by a DNN, in response to determining that the data structure is in the data structure category, retrieving a plurality of schedule trees associated with the data structure category, where each schedule tree includes one or more schedules, and a schedule specifies a loop transformation of the loop nest, and generating a new schedule tree for the data structure by merging at least some of the plurality of schedule trees, where the new schedule tree is to be used to transform the loop nest.
Example 16 provides the apparatus of example 15, where determining whether the data structure falls under the data structure category includes determining whether the tensor operation matches a tensor operation in the data structure category.
Example 17 provides the apparatus of example 16, where determining whether the data structure falls under the data structure category further includes determining whether one or more tensor references in the data structure match corresponding one or more tensor references in the data structure category, where a tensor reference is a tensor rank, tensor shape, or a tensor length.
Example 18 provides the apparatus of any one of examples 15-17, further including selecting a group of schedule trees from the plurality of schedule trees, where the group of schedule trees is a subset of the plurality of schedule trees, and generating the new schedule tree includes generating the new schedule tree by merging the group of schedule trees.
Example 19 provides the apparatus of example 18, where selecting the group of schedule trees from the plurality of schedule trees includes removing one or more schedule trees from the plurality of schedule trees.
Example 20 provides the apparatus of example 19, where removing the one or more schedule trees from the plurality of schedule trees includes for each respective schedule tree of the plurality of schedule trees, determining a similarity score indicating a similarity between the data structure and a corresponding data structure of the plurality of data structures; and removing the one or more schedule trees based on similarity scores of the one or more schedule trees.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

1-25. (canceled)

26. A method for deep learning, the method comprising:
generating a plurality of schedules for a data structure comprising a loop nest, wherein the loop nest comprises a plurality of loops, a loop specifies a tensor operation to be repeatedly executed by a deep neural network (DNN), and a schedule specifies a transformation of the loop nest;
for each respective schedule of the plurality of schedules, inputting one or more attributes of the data structure after being transformed by the respective schedule into a trained model, the trained model outputting a predicted performance score indicating an evaluation of a predicted performance of the DNN;
selecting a schedule from the plurality of schedules based on predicted performance scores of the plurality of schedules;
transforming the loop nest in the data structure based on the schedule, wherein after the loop nest is transformed based on the schedule, the data structure is used for an execution of the tensor operation by the DNN;
receiving information indicating a runtime performance of the DNN in the execution of the tensor operation; and
updating the training model based on an evaluation of the runtime performance of the DNN.

27. The method of claim 26, wherein updating the training model based on the evaluation of the runtime performance of the DNN comprises:
determining a runtime performance score indicating the evaluation of the runtime performance of the DNN;
forming a training sample that comprises the runtime performance score and one or more parameters associated with the schedule; and
further training the trained model by using the training sample.

28. The method of claim 26, further comprising:
selecting a different schedule from the plurality of schedules by using the trained model that has been updated; and
transforming the loop nest in the data structure based on the different schedule, wherein after the loop nest is transformed based on the different schedule, the data structure is used for a new execution of the tensor operation by the DNN.

29. The method of claim 26, wherein generating the plurality of schedules for the data structure comprises:
determining whether a data structure is in a data structure category in a database;
in response to determining that the data structure is in the data structure category, retrieving, from the database, candidate schedules associated with the data structure category; and
generating the plurality of schedules from the candidate schedules.

30. The method of claim 29, wherein the candidate schedules comprise a first candidate schedule and a second candidate schedule, and generating the plurality of schedules for the data structure comprises:
determining a similarity score indicating a similarity between the data structure and a data structure associated with the first candidate schedule; and
after determining that the similarity score is lower than a threshold score, generating the plurality of schedules based on the second candidate schedule and not based on the first candidate schedule.

31. The method of claim 29, wherein the candidate schedules comprise a first candidate schedule and a second candidate schedule, the first candidate schedule specifies a loop tiling for splitting a loop in the loop nest into multiple loops, and generating the plurality of schedules for the data structure comprises:
determining that the loop tiling is incompatible with a tensor associated with the loop; and
generating the plurality of schedules based on the second candidate schedule and not based on the first candidate schedule.

32. The method of claim 26, wherein generating the plurality of schedules for the data structure comprises:
partitioning the loop nest into a number of memory loop nests, wherein each of the loop nest and memory loop nests includes a sequence of loops, a loop indicates a tensor operation to be repeatedly executed by a processor, a loop in the loop nest is partitioned into the number of loops, each of which is in a different memory loop nest of the number of memory loop nests and corresponds to a different memory associated with the processor;
determining loop extents of loops in a memory loop nest of the number of loop nests, a loop extent of a loop indicating a number of times a tensor operation in the loop to be repeatedly executed; and
generating the plurality of schedules based on the loop extents.

33. The method of claim 32, wherein the memory loop nest is a first memory loop nest, and generating the plurality of schedules for the data structure further comprises:
determining one or more permutations for a second memory loop nest of the number of loop nests, each permutation indicating a change in an order of loops in the second memory loop nest;
determine loop extents of the loops in the second memory loop nest based on the one or more permutations; and
generating the plurality of schedules further based on the one or more permutations for the second memory loop nest and the loop extents of the loops in the second memory loop nest.

34. The method of claim 33, wherein determine the loop extents of the loops in the second memory loop nest comprises:
determining a plurality of candidate sets, each candidate set including candidate loop extents for the loops in the second memory loop nest;
for each respective candidate set, inputting the candidate loop extents in the candidate set and the one or more attributes of the data structure into an additional trained model, the additional trained model outputting a miss score indicating predicted misses of a memory corresponding to the second memory loop nest if the DNN executes the tensor operation based on the data structure in which the loop nest is transformed based on the respective candidate set; and
selecting a candidate set from the plurality of candidate sets based on miss scores of the plurality of candidate sets, wherein the candidate set includes the loop extents of the loops in the second memory loop nest.

35. The method of claim 26, wherein the one or more attributes of the data structure after being transformed by the respective schedule are selected from a group consisting of a type of the tensor operation, a loop nest extent indicating a number of times the tensor operation to be repeatedly executed by the DNN, a tensor rank associated with the tensor operation, a tensor shape associated with the tensor operation, and a tensor length associated with the tensor operation.

36. One or more non-transitory computer-readable media storing instructions executable to perform operations for deep learning, the operations comprising:
generating a plurality of schedules for a data structure comprising a loop nest, wherein the loop nest comprises a plurality of loops, a loop specifies a tensor operation to be repeatedly executed by a deep neural network (DNN), and a schedule specifies a transformation of the loop nest;
for each respective schedule of the plurality of schedules, inputting one or more attributes of the data structure after being transformed by the respective schedule into a trained model, the trained model outputting a predicted performance score indicating an evaluation of a predicted performance of the DNN;
selecting a schedule from the plurality of schedules based on predicted performance scores of the plurality of schedules;
transforming the loop nest in the data structure based on the schedule, wherein after the loop nest is transformed based on the schedule, the data structure is used for an execution of the tensor operation by the DNN;
receiving information indicating a runtime performance of the DNN in the execution of the tensor operation; and
updating the training model based on an evaluation of the runtime performance of the DNN.

37. The one or more non-transitory computer-readable media of claim 36, wherein updating the training model based on the evaluation of the runtime performance of the DNN comprises:
determining a runtime performance score indicating the evaluation of the runtime performance of the DNN;
forming a training sample that comprises the runtime performance score and one or more parameters associated with the schedule; and
further training the trained model by using the training sample.

38. The one or more non-transitory computer-readable media of claim 36, wherein operations further comprise:
selecting a different schedule from the plurality of schedules by using the trained model that has been updated; and
transforming the loop nest in the data structure based on the different schedule, wherein after the loop nest is transformed based on the different schedule, the data structure is used for a new execution of the tensor operation by the DNN.

39. The one or more non-transitory computer-readable media of claim 36, wherein generating the plurality of schedules for the data structure comprises:
determining whether a data structure is in a data structure category in a database;
in response to determining that the data structure is in the data structure category, retrieving, from the database, candidate schedules associated with the data structure category; and
generating the plurality of schedules from the candidate schedules.

40. The one or more non-transitory computer-readable media of claim 36, wherein generating the plurality of schedules for the data structure comprises:
partitioning the loop nest into a number of memory loop nests, wherein each of the loop nest and memory loop nests includes a sequence of loops, a loop indicates a tensor operation to be repeatedly executed by a processor, a loop in the loop nest is partitioned into the number of loops, each of which is in a different memory loop nest of the number of memory loop nests and corresponds to a different memory associated with the processor;
determining loop extents of loops in a memory loop nest of the number of loop nests, a loop extent of a loop indicating a number of times a tensor operation in the loop to be repeatedly executed; and
generating the plurality of schedules based on the loop extents.

41. The one or more non-transitory computer-readable media of claim 40, wherein the memory loop nest is a first memory loop nest, and generating the plurality of schedules for the data structure further comprises:
determining one or more permutations for a second memory loop nest of the number of loop nests, each permutation indicating a change in an order of loops in the second memory loop nest;
determine loop extents of the loops in the second memory loop nest based on the one or more permutations; and
generating the plurality of schedules further based on the one or more permutations for the second memory loop nest and the loop extents of the loops in the second memory loop nest.

42. The one or more non-transitory computer-readable media of claim 36, wherein the one or more attributes of the data structure after being transformed by the respective schedule are selected from a group consisting of a type of the tensor operation, a loop nest extent indicating a number of times the tensor operation to be repeatedly executed by the DNN, a tensor rank associated with the tensor operation, a tensor shape associated with the tensor operation, and a tensor length associated with the tensor operation.

43. An apparatus for deep learning, the apparatus comprising:
a computer processor for repeatedly executing a tensor operation in accordance with computer program instructions; and
a tensor compiler configured to perform operations comprising:
generating a plurality of schedules for a data structure comprising a loop nest, wherein the data structure is generated based on the computer program instructions, the loop nest comprises a plurality of loops, a loop specifies the tensor operation to be repeatedly executed by the processor, and a schedule specifies a transformation of the loop nest,
for each respective schedule of the plurality of schedules, inputting one or more attributes of the data structure after being transformed by the respective schedule into a trained model, the trained model outputting a predicted performance score indicating an evaluation of a predicted performance of the processor,
selecting a schedule from the plurality of schedules based on predicted performance scores of the plurality of schedules,
transforming the loop nest in the data structure based on the schedule, wherein after the loop nest is transformed based on the schedule, the data structure is used for an execution of the tensor operation by the processor,
receiving information indicating a runtime performance of the processor in the execution of the tensor operation, and
updating the training model based on an evaluation of the runtime performance of the processor.

44. The apparatus of claim 43, wherein updating the training model based on the evaluation of the runtime performance of the processor comprises:
determining a runtime performance score indicating the evaluation of the runtime performance of the processor;
forming a training sample that comprises the runtime performance score and one or more parameters associated with the schedule; and
further training the trained model by using the training sample.

45. The apparatus of claim 43, wherein the operations further comprise:
selecting a different schedule from the plurality of schedules by using the trained model that has been updated; and
transforming the loop nest in the data structure based on the different schedule, wherein after the loop nest is transformed based on the different schedule, the data structure is used for a new execution of the tensor operation by the processor.
